(19) United States
(12) Patent Application Publication
(10) Pub. No.: US 2014/0087848 A1
(43) Pub. Date: Mar. 27, 2014

(54) PERCEIVED SKILL GAMING TECHNIQUES FOR CONTROLLING GAME EVENT INFLUENCE AND/OR OUTCOME IN GAMING ENVIRONMENTS

(71) Applicants: James Peter Kosta, Gardnerville, NV (US); William Joseph McMaster, Las Vegas, NV (US)

(72) Inventors: James Peter Kosta, Gardnerville, NV (US); William Joseph McMaster, Las Vegas, NV (US)

(73) Assignee: Centennial Corporation, Reno, NV (US)

(21) Appl. No.: 14/034,511

(22) Filed: Sep. 23, 2013

Related U.S. Application Data
(60) Provisional application No. 61/704,489, filed on Sep. 22, 2012.

(51) Int. Cl. G07F 17/32

(52) U.S. Cl. CPC G07F 17/3267
USPC 463/25

(57) ABSTRACT

Various aspects described herein are directed to different techniques for facilitating implementation and use of perceived skill gaming techniques for controlling game event influence and/or game outcomes in single and/or multiplayer, wager-based and/or non-wager based gaming environments.

### RELATED APPLICATION DATA

The present application claims benefit, pursuant to the provisions of 35 U.S.C. §119, of U.S. Provisional Application Ser. No. 61/704,489 (Attorney Docket No. ODTYP001P), titled “PERCEIVED SKILL GAMING TECHNIQUES FOR CONTROLLING GAME EVENT INFLUENCE AND/OR OUTCOME IN GAMING ENVIRONMENTS”, naming KOSTA et al. as inventors, and filed 22 Sep. 2012, the entirety of which is incorporated herein by reference for all purposes.

### BACKGROUND

The present disclosure relates to multi-player and/or single player gaming environments. More particularly, the present disclosure relates to perceived skill gaming techniques for controlling game event influence and/or outcome in gaming environments.

### BRIEF DESCRIPTION OF THE DRAWINGS

FIG. 1 illustrates a simplified block diagram of a specific example embodiment of a portion of a Computer Network 100.

FIG. 2 is a simplified block diagram of an exemplary gaming machine 200 in accordance with a specific embodiment.

FIG. 3 shows a diagrammatic representation of machine in the exemplary form of a client (or end user) computer system 300.

FIG. 4 is a simplified block diagram of an exemplary Mobile Device 400 in accordance with a specific embodiment.

FIG. 5 illustrates an example embodiment of a Server System 580 which may be used for implementing various aspects/features described herein.

FIG. 6 illustrates an example of a functional block diagram of a Server System 600 in accordance with a specific embodiment.

FIGS. 7-9 provide example procedural flows relating to various perceived skill gaming techniques which may be used for facilitating, enabling; initiating, and/or performing one or more game event influence/outcome operation(s), action(s), and/or feature(s) described and/or referenced herein.

FIG. 10 shows a block diagram illustrating components of a gaming system 900 which may be used for implementing various aspects of example embodiments.

### DETAILED DESCRIPTION OF EXAMPLE EMBODIMENTS

### Overview

Various aspects described or referenced herein are directed to different methods, systems, and computer program products for facilitating implementation and use of perceived skill gaming techniques for controlling game event influence and/or game outcomes in gaming environments.

One aspect disclosed herein is directed to different methods, systems, and computer program products for facilitating implementation and use of perceived skill gaming techniques for controlling game event influence and/or game outcomes in single and/or multiplayer, wager-based and/or non-wager based gaming environments. In at least one embodiment, various method(s), system(s) and/or computer program product(s) may be operable to: control a first gaming session relating to a first wager-based Perceived Skill Game conducted at a first gaming machine; predetermine a first final game outcome associated with a first player participating in the first gaming session; receive, during the first gaming session, first game play input from the first player via the first gaming machine; dynamically effect a game state of the first gaming session using the received first game play input; generate, via an automated computerized process, first Perceived Game Control instructions (“PSG instructions”) for dynamically affecting the game state of the first gaming session in a manner which facilitates an occurrence of the first final game state outcome at the end of the first gaming session; and; dynamically effect, using the first Perceived Game Control instructions, the game state of the first gaming session to thereby cause the occurrence of the first final game state outcome at the end of the first gaming session.

In some embodiments, various method(s), system(s) and/or computer program product(s) may further be operable to: predetermine a second final game outcome associated with a second player participating in the first gaming session; receive, during the first gaming session, second game play input from the second player via a second gaming machine; dynamically effect a game state of the first gaming session using the received second game play input; generate, via an automated computerized process, second Perceived Game Control instructions (“PSG instructions”) for dynamically affecting the game state of the first gaming session in a manner which facilitates an occurrence of the second final game state outcome at the end of the first gaming session; and; dynamically effect, using the second Perceived Game Control instructions, the game state of the first gaming session to thereby cause the occurrence of the second final game state outcome at the end of the first gaming session.

In other embodiments, various method(s), system(s) and/or computer program product(s) may further be operable to perform one or more of the following (or combinations thereof): dynamically effect, using the first Perceived Game Control instructions, at least one environmental variable relating to game play activity of the first gaming session to thereby cause the occurrence of the first final game state outcome at the end of the first gaming session; dynamically effect the first player's performance and/or achievements in the first gaming session using the received first game play input; dynamic effect the game state of the first gaming session using the first Perceived Game Control instructions in a manner so as not to make the first player aware of the predetermination of the first final game outcome; predetermine the first final game outcome before an occurrence of an end of the first gaming session; determine the first final game outcome before the first player engages in active game play activities in the first gaming session; determine the first final game outcome in a manner which is not influenced by the first player's game play input during the first gaming session; prevent the determination of the first final game outcome from being influenced by the first player's game play input during the first gaming session; prevent the first player's game play input during the first gaming session from influencing the first final game outcome of the first gaming session; and/or; dynamically adjust an amount of influence that the first player's game play input has on the game state of the first gaming session in a manner which facilitates the occurrence of the first final game state outcome at the end of the first gaming session.

Various objects, features and advantages of the various aspects described or referenced herein will become apparent from the following descriptions of its example embodiments, which descriptions should be taken in conjunction with the accompanying drawings.

### SPECIFIC EXAMPLE EMBODIMENTS

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders or in parallel. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

Various aspects described or referenced herein are directed to different methods, systems, and computer program products for facilitating implementation and use of perceived skill gaming techniques for controlling game event influence and/or game outcomes in gaming environments. For example, in at least one embodiment, a gaming system may be configured or designed provide a player participating in a game of chance (e.g., wager-based game, game w/ random outcome, etc.) with the perception that the player has control over influencing the game outcome or control over influencing a game event outcome.

Games of Chance (GoC)

In at least one embodiment, a Game of chance may be defined as a game in which the outcome is determined by a random event (RE), Random Number Generator (RNG), Math Model (MM), an algorithm, etc. By way of example, games of chance are typically deployed at Electronic Gaming Machines (EGMs) such as, for example: a Video Slot Machine (VS), a Video Poker (VP) gaming machine and/or other types of EGMs commonly deployed at modern, regulated terrestrial Casinos.

For example, when a player initiates a game play session at the conventional wager-based slot machine, the only input or decision opportunities provided to the player (other than amount to be wagered) is in when to begin the game. For example, the Player may place his wager, and may control the decision as to when to press the Spin/Start button to initiate spinning of the reels. In at least one embodiment, this action by the player may cause the slot machine to processes a random event using it's RNG and to determine an appropriate win/loss/end event, based on the game's MM. The outcome or “result” is displayed to the player as symbols in various shapes or alignments on Reels.

In at least one embodiment, the game outcome is determined in real-time (e.g. within a few seconds after the player has initiated start of game play) while the reels of the slot machine are still spinning Thereafter, the spinning reels of the slot machine are caused to stop at predetermined positions matching the predetermined game outcome. Thus, for example, the game outcome is not determined at the time when the spinning reels finally come to rest, but rather the game outcome has been predetermined (e.g., using an RNG and/or a suitable math model, algorithm, etc.) and the final resting positions of the reels are dynamically manipulated by the slot machine to display the (predetermined) game outcome/result.

For example GoC's may be configured or designed to utilize a S-D-R-D (Start->Determine->Result->Display) technique as illustrated, for example, in the Example Method A below.

### Example Method A

SPIN Reels
->Request made to RNG
->RNG & MM determine the result and tell the EGM
->EGM Display the proper symbol to the Player.

However, unlike conventional gaming techniques such as the slot machine in which the player perceives that he or she is unable to influence the game outcome after gameplay has been initiated (e.g., after player has been initiated spinning of the slot machine reels), the perceived skill gaming techniques described herein provide the player with a real-time game play experience in which the player is caused to perceive that the player has direct input/control over a given object or outcome in the game; and/or that the player's input/timing/skill has a direct connection to the player's performance/achievement(s)/outcome in the Game of Chance. In this way, the player's experience of the game play may be caused to be more suspenseful and engaging and/or may result in the building up of more excitement and anticipation for the player.

Games of Skill vs Games of Chance

According to the law there are differences between games of chance and games of skill. And it is based on this difference that it is decided whether or not a particular game should be allowed or not. For example the game of poker is considered to be a game of skill even though it is not a sport. In poker the outcome of the game depends mainly on the skills of the players. However, chance too plays a small role and even though a player might be very skilled it does not always guarantee a win. For this reason, it can be said that poker does have an element of chance but since it is mainly a skill based game it is considered to be a game of skill.

There are at least two main differences between games of chance and games of skill. The first difference is who the player is playing against. When a player is playing against the house, it is a game of chance. When the player is pitted against other players, it is considered to be a game of skill. Also, if an individual can prove that a particular game involves the use of skill like strategies, statistics or math along with a factor of luck or chance, the game may be categorized as game of skill.

Perceived Skill Gaming (PSG) Techniques

As disclosed previously, various aspects described or referenced herein are directed to different methods, systems, and computer program products for facilitating implementation and use of perceived skill gaming techniques for controlling game event influence and/or game outcomes in gaming environments. For example, in at least one embodiment, a gaming system may be configured or designed to provide a player participating in a game of chance (e.g., wager-based game, game w/random outcome, etc.) with a perceived experience (e.g., in real-time) of playing a game of chance (e.g., in which the player has control over influencing the game outcome or control over influencing a game event outcomes).

According to different embodiments, the perceived skill gaming techniques disclosed herein may be implemented using a variety of different mechanisms such as, for example, one or more of the following (or combinations thereof): via physics, graphics, perspective, input, feedback, etc.

For example, in at least one embodiment, a game of chance may be configured or designed to provide a person (“Player”) playing a Game of chance with a real-time game play experience where the player is caused to experience a look and feel (or “Perception”) that:
The Player has a configurable degree of input, control, or influence over a given object or outcome in the game;
The Player's input, timing, and/or skill has a degree of impact or effect to that player's performance, achievement(s), and/or game event outcome(s) in a Game of Chance (GoC);
The Player is not made aware that the final game outcome (and/or one or more game event outcome(s)) has been predetermined and/or is not made aware that the final game outcome (and/or one or more game event outcome(s)) is based only on randomness, and may be unaffected by the player's game play input and/or actions.

According to specific embodiments, perceived skill gaming techniques may be implemented using various different methods, systems, computer program products, etc., and may be implemented in a manner which adds additional levels of input and/or feedback to the player (as compared with conventional GoCs).

According to different embodiments, different types of perceived skill gaming techniques may be implemented in and/or applied to a variety of different types of games such as, for example, one or more of the following (or combinations thereof):
Racing/Driving (Cars, boats, planes etc.)
Sports (Football, Baseball, downhill skiing, etc.
Challenge games (Archery, Darts, Shooting, etc.)
Recreation Games (Horseshoes, Croquet, Fishing etc.
Arcade-type Games etc.
Wager-based (e.g., casino-type) games
And/or any other types of games in which substantially randomized event outcomes may occur.

For example, according to different embodiments, one or more of the various game types described above may be adapted and/or modified to be a PSG-type game in which the game outcome is determined in accordance with a “game of chance”, and in which the perceived game play experience (from the perspective of player) is similar to that of a game of skill. In one embodiment, the player may interact with the PSG-type game as he or she would in a conventional game of skill (e.g., a Skill Based Game (SBG)). However, in at least one embodiment, the PSG-type game may be linked to or based on a GoC, and may use GoC-type elements as its core game outcome determination mechanism. In this way, the PSG-type game allows the player to play a game that “feels” like a SBG, but the result is determined as in a GoC.

Benefits, Features, and Advantages of Perceived Skill Gaming Techniques
Typical PSG game session may last longer that a GoC.
The Player has much more interaction with the PSG game, and which results in increased player excitement and enjoyment of the PSG game.
The player's input during the gaming session (e.g., during game play) may be used to influence the visual display or appearance of images, action(s), and/or event outcome(s) in a game. For example, in at least one embodiment, the player's input, timing, and/or skill may have a dynamically adjustable degree of impact or effect on that player's performance, achievement(s), and/or game event outcome(s).
PSG-type games typically do not resemble GoC type games. Rather, PSG-type games may resemble more entertaining or Skill Based Games such as those provided via more expensive Server Based Gaming (SBG) systems.
PSG-type games typically require less regulatory oversight than SBG-type games, and are easier to authenticate and verify for regulatory inspection purposes.

The following examples are intended to help illustrate some of the various types of functions, operations, actions, and/or other features which may be provided by the PSG techniques described herein.

### PSG Example 1

### (Archery)—Hit The Bulls Eye and Win a Big Prize

In this PSG embodiment, the player is given several choices above and beyond how much the player wish to wager. (as in a strict GoC like a VS) The player can select their Bow, Arrow, Power, Angle, and Timing etc. When the player indicates that the player is “Ready”, a timer begins allowing them to set up their shot. If the player is not ready before the timer hits zero, the arrow is automatically launched and the game is played.

Once the player is all set, the player Releases the arrow. Once the arrow is in flight the player can guide the arrow in direction Up/Down/Left/Right, towards the target. The arrow will hit the area on the target that the GoC (e.g., GoC core) determined it to hit, regardless of the players actions. This is done in such a manner to mask the predetermined outcome and is achieved via various PSG Control Mechanisms (PSG-CM), which, for example, may be implemented via one or more different mechanisms such as, for example, one or more of the following (or combinations thereof):
Environmental persuasion
Unexpected event(s)
Other types of PSG Control Mechanisms which may be employed to dynamically influence game play activity/event(s) to achieve a predetermined game outcome while masking the predetermined outcome from the perspective of the active player(s).

For example, the reference for a typical GoC Game Play Sequence in an EGM may be expressed as: S-D-R-D (Start->Determine->Result->Display). However, according to different embodiments, the reference for a PSG Game Play Sequence (in accordance with one or more PSG techniques described herein) may be expressed as: E-S-S-D-R-ICE-D (Enter->Select->Start->Determine->Result->Interaction & PSG-CMs-Display).

Example Archery PSG Procedural Flow
1. Enter—(Player enters game/wager)
2. Select—(Player selects Bow, Arrow, Angle, and Power)
3. Start—(Player selects “Ready Button”—The “Ready Button” issues a “game start” (or “gaming session begin”) event in the background and makes a request to the GoC's RNG or MM.
4. Determine—The GoC (e.g., GoC core) determines the game outcome based on the GoC's RNG or MM.
5. Result—The final result or game outcome is sent from the GoC to the PSG Engine. (e.g., Result=Player Hits #5 Ring). In at least one embodiment, this may be implemented as a background process.
6. Interaction & PSG-CM's—GAME PLAY Foreground. In at least one embodiment, game play activity/event(s) are automatically and dynamically influenced by the PSG Engine to achieve previously determined Game Outcome of current gaming session using suitable PSG Control Mechanism(s). For example:
   6A: [Interaction] The player “Lines up a Bulls Eye” (e.g., #10 Ring), launches the arrow, and begins to guide the arrow to the target, for example, by touching the screen Up-Down->Left->Right.
   6B: [PSG-CMs] A strong “wind” blows the arrow off courses prior to hitting the target thereby causing player's arrow to hit #5 ring, which corresponds to the previously determined game outcome/result.
7. Display—Final game outcome/result is displayed. The arrow sticks into the #5 Ring (as determined in operations 4&5 above)

### PSG Example 2

### Driving—e.g., Monster Truck

Player controls steering and acceleration
In this PSG the player is also given several choices above and beyond how much the player wish to wager (e.g., as in a strict GoC like a VS). The player can select their racing vehicle, customize it, and even control it on the track.
When the player selects that the player is “Ready” a race (e.g., gaming session) begins. The player can influence the steering of the vehicle the player is racing, as well as “boost” the vehicle for a temporary acceleration burst. In one embodiment, the vehicle will navigate the track without player interaction, however the player can influence the vehicle during the race.
In some embodiments, the PSG game may be configured or designed as a multi-player game, where multiple different players compete in the same race.
In at least one embodiment, the winner of the race has been predetermined
Each player's control is influenced in such a way as to conceal or mask the dynamic influencing of game play activity/event(s) toward the predetermined game outcome. This is done in such a manner to mask the predetermined outcome and may be achieved via implementation of one or more PSG Control Mechanisms (PSG-CM) such as, for example: Environmental persuasion, Unexpected event(s), physics based effects like slipping or spinning out of control, etc.
In at least one embodiment, the PSG Game Play Sequence may be expressed as: E-S-S-D-R-ICE-D (Enter->Select->Start->Determine->Result->Interaction & PSG-CMs-Display)
In at least one embodiment, a player begins the race in equal standing with other racers/players. In other embodiments, one or more players may begin the race with unequal standing with respect to other racers/players. However, in either of these embodiments, the predetermined outcome is always reached at the end of the game.

Example Monster Truck PSG Procedural Flow
1. Enter—(Player enters game/wager)
2. Select—(Player selects Vehicle and Customizes it)
3. Start—(Player selects “Ready Button”—The “Ready Button” issues a “game start” (or “gaming session begin”) event in the background and makes a request to the GoC's RNG or MM.
4. Determine—The GoC (e.g., GoC core) determines the game outcome based on the GoC's RNG or MM.
5. Result—The Final Result is sent from the GoC core to the PSG Engine. (e.g., Result=Player comes in 4th). In at least one embodiment, this may be implemented as a background process.
6. Interaction & PSG-CM's (These happen simultaneously) GAME PLAY Foreground. In at least one embodiment, game play activity/event(s) are automatically and dynamically influenced by the PSG Engine to achieve previously determined Game Outcome of current gaming session using suitable PSG Control Mechanism(s). For example:
   6A: [Interaction] The player influences the car throughout the race via input mechanisms such as steering wheel, brake, gas, gear shift, etc.
   6B: [PSG-CM's] Various different types of PSG control mechanisms may be employed such as, for example, one or more of the following (or combinations thereof):
      Dynamic introduction of environmental persuasion, unexpected event(s), and/or physics based effects (e.g., like slipping or spinning out of control), etc.
      Dynamically adjusting the player's influence (e.g. dynamically adjusting the influence attributable to the player's input) in proportion to the progress of the race and the player's relative position in the race. For example, if the player is currently in position 1, 2, or 3, the player's influence may be automatically and dynamically diminished as the race progress towards the end of the game. If the player is currently in position 4 (which is the predetermined game outcome for that player), the player's influence may remain about the same (e.g., relative to the past), or the player's influence may be dynamically diminished to a lesser degree than if the player were in position 1, 2, or 3. If the player's current position is below 4 (e.g., 5, 6, 7, etc.), the player's influence may be automatically and dynamically diminished as the race progress towards the end of the game, and other PSG-CMs may be employed to boost the player's position into 4^{th} place by the end of the race.
7—Display—The race concludes with the player in 4th place (as previously determined)

### PSG Example 3

### (Pinball)—Player Controls Paddles which Deflect the Ball Before it Rolls Out of Play

In this PSG game, the Player is able to wager on a game which he knows is random (e.g., the physics of the ball), yet expects he will be able to control the paddles which keep the ball in the play.
When the ball is put into play by the Player, the result of the round is predetermined (e.g., by GoC Engine). The PSG Control Engine manipulates the system to automatically calculate the trajectory of the ball in such a way as to score the predetermined number of points. The movement of the ball is so fast, and deflection angles so minute, that the player feels the trajectory of the ball is completely random.
In at least one embodiment, when the ball approaches the Player-controlled paddles, if the Player does not push the paddle button, the ball will slightly alter its course to hit the paddle regardless. The speed at which the ball travels makes it nearly impossible for the player to perceive the alteration of path.
In this PSG game type, if it has been predetermined that the player will win, the player may be given control of the paddles and be able to deflect the ball using non-deterministic physics to determine the player's bonus. In this game, and other similar embodiments, the player may be provided with the ability to obtain substantially skill-based outcomes from time to time to determine their bonus or multiplier, for example.

In at least some embodiments, one or more of the processes, steps, or activities described in the example above may be implemented in different sequential orders that those described above. Additionally, in at least some embodiments, one or more of the processes, steps, or activities described in the example above may be implemented concurrently or in parallel with each other.

Various types of PSG Control Mechanisms may be employed to dynamically influence game play activity/event(s) to achieve a predetermined game outcome, while masking the predetermined outcome from the awareness of the active player(s). Examples of different types of game session variables, criteria, and/or events which may be utilized as PSG-CMs (e.g., for Monster Truck Race Game or other types of PSGs) may include, but are not limited to, one or more of the following (or combinations thereof):
maximum speed of vehicle increased/decreased;
average speed of vehicle increased/decreased;
real-time speed of vehicle increased/decreased;
road conditions dynamically altered to cause speed of vehicle to be increased/decreased;
center of gravity of vehicle raised or lowered to dynamically increase/decrease turning performance of vehicle;
increase/decrease turning performance of vehicle;
increase/decrease cornering performance of vehicle;
increase/decrease amount of distance vehicle travels in the air when going off jumps;
influence direction of vehicle towards next waypoint;
dynamically decrease level of players control over gameplay as game nears its end;
dynamically adjust minimum/maximum values for various characteristics are properties of gaming objects (e.g., vehicles);
dynamically alter environmental variables such as, for example: wind drag, road conditions, visibility, bystander interference, vehicle traction, gas consumption, etc.;
dynamically determining (e.g., in real-time) distribution of in-game awards (e.g., during game play) after players input has been received, and using the received player input to dynamically determine (e.g., in real-time) distribution of in-game awards (during game play) so that the player receives a desired or predetermined amount of in game awards over a given time period;
linearly or non-linearly reduce the amount of control and influence that a player has during game play as the game nears the final game outcome;
dynamically increase the performance or odds of winning for the player who has been pre-determined to be the winner;
dynamically decrease or drag down the performances or odds of winning for the other players who have not been pre-determined to be the winner;
dynamically alter variables and/or characteristics of game to dynamically (e.g., in real-time) increase the probability (e.g., to 100%) of achieving a predetermined or desired game outcome;
and/or other types of types of game session variables, criteria, and/or events which may be utilized as PSG-CMs to dynamically influence game play activity/event(s) to achieve a predetermined game outcome.

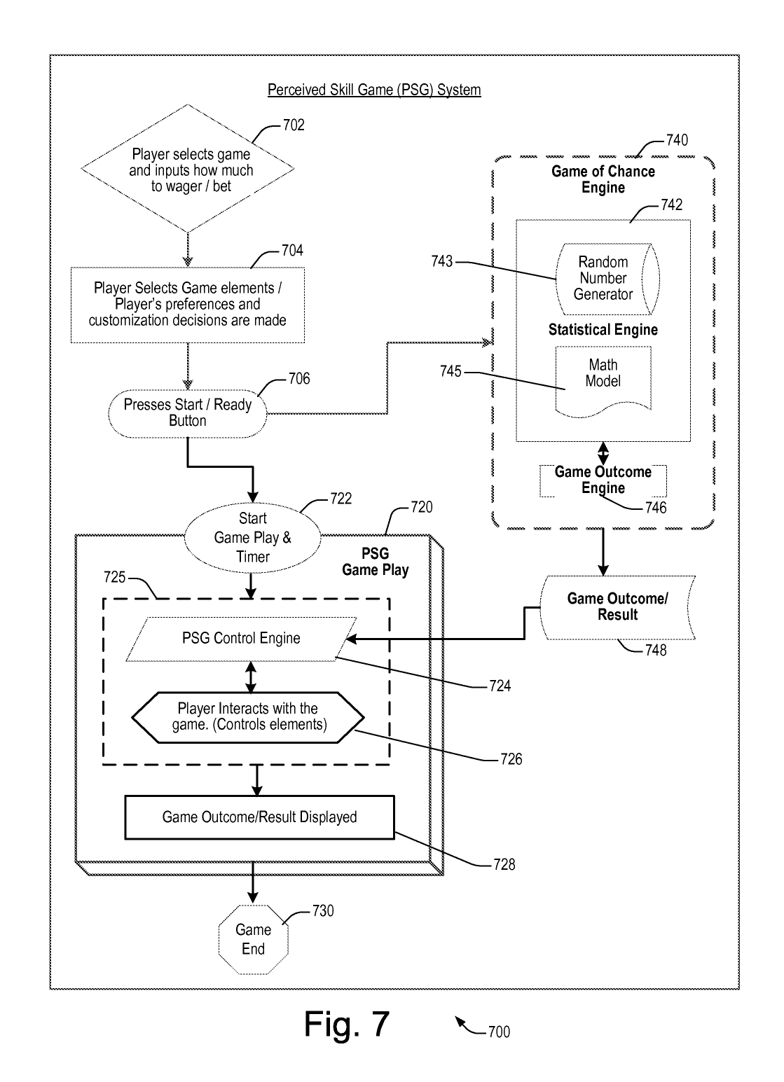

FIGS. 7-9 provide example procedural flows relating to various perceived skill gaming techniques which may be used for facilitating, enabling; initiating, and/or performing one or more game event influence/outcome operation(s), action(s), and/or feature(s) described and/or referenced herein.

In at least one embodiment, one or more of the perceived skill gaming procedures may be operable to utilize and/or generate various different types of data and/or other types of information when performing specific tasks and/or operations. This may include, for example, input data/information and/or output data/information. For example, in at least one embodiment, the perceived skill gaming procedures may be operable to access, process, and/or otherwise utilize information from one or more different types of sources, such as, for example, one or more local and/or remote memories, devices and/or systems. Additionally, in at least one embodiment, the perceived skill gaming procedures may be operable to generate one or more different types of output data/information, which, for example, may be stored in memory of one or more local and/or remote devices and/or systems. Examples of different types of input data/information and/or output data/information which may be accessed and/or utilized by the perceived skill gaming procedures may include, but are not limited to, one or more of those described and/or referenced herein.

In at least one embodiment, a given instance of the perceived skill gaming procedures may access and/or utilize information from one or more associated databases. In at least one embodiment, at least a portion of the database information may be accessed via communication with one or more local and/or remote memory devices. Examples of different types of data which may be accessed by the perceived skill gaming procedures may include, but are not limited to, one or more of those described and/or referenced herein.

According to specific embodiments, multiple instances or threads of the perceived skill gaming procedures may be concurrently implemented and/or initiated via the use of one or more processors and/or other combinations of hardware and/or hardware and software. For example, in at least some embodiments, various aspects, features, and/or functionalities of the perceived skill gaming procedures may be performed, implemented and/or initiated by one or more of the various systems, components, systems, devices, procedures, processes, etc., described and/or referenced herein.

According to different embodiments, one or more different threads or instances of the perceived skill gaming procedures may be initiated in response to detection of one or more conditions or events satisfying one or more different types of minimum threshold criteria for triggering initiation of at least one instance of the perceived skill gaming procedures. Various examples of conditions or events which may trigger initiation and/or implementation of one or more different threads or instances of the perceived skill gaming procedures may include, but are not limited to, one or more of those described and/or referenced herein.

According to different embodiments, one or more different threads or instances of the perceived skill gaming procedures may be initiated and/or implemented manually, automatically, statically, dynamically, concurrently, and/or combinations thereof. Additionally, different instances and/or embodiments of the perceived skill gaming procedures may be initiated at one or more different time intervals (e.g., during a specific time interval, at regular periodic intervals, at irregular periodic intervals, upon demand, etc.).

In at least one embodiment, initial configuration of a given instance of the perceived skill gaming procedures may be performed using one or more different types of initialization parameters. In at least one embodiment, at least a portion of the initialization parameters may be accessed via communication with one or more local and/or remote memory devices. In at least one embodiment, at least a portion of the initialization parameters provided to an instance of the perceived skill gaming procedures may correspond to and/or may be derived from the input data/information.

FIG. 7 shows an example interaction diagram of a Perceived Skill Game (PSG) system which may be used for implementing various aspects/features described herein.

As shown at 702, a player may select a particular game (e.g., wager-based game) which is available for play at the PSG gaming device and inputs how much to wager/bet.

As shown at 704, the player may select and provide input regarding preferred game elements, customizations, and/or player's preferences.

As shown at 706, a player may initiate the start of a game (e.g., the start of a gaming session), such as, for example, by pressing or engaging a start button or by providing other input indicating that the player is ready to begin game play. In at least one embodiment, the engaging of the Start Button may serve as a triggering event which, in turn, may cause appropriate signals to be generated and sent to Game of Chance Engine 740 and PSG Game Play Components 720.

As illustrated in the example embodiment of FIG. 7, the Perceived Skill Game System includes a Game of Chance Engine 740 which may be configured or designed to include functionality for determining a game outcome for the identified game. According to different embodiments, Game of Chance Engine 740 may be configured or designed to determining a Game Outcome (748) via use of Statistical Engine 742 and Game Outcome Engine 746. In at least one embodiment, the Statistical Engine 742 may be configured or designed to utilize a Random Number Generator (RNG) 743, Math Model (MM) 745, and/or other algorithm. In at least one embodiment, the Statistical Engine 742 may work together with the Game Outcome Engine 746 to generate a randomized (or statistically appropriate) Game Outcome/Result 748 for the identified PSG game being played.

Additionally, as illustrated in the example embodiment of FIG. 7, the Perceived Skill Game System includes PSG Game Play Components 720 which may be configured or designed to facilitate PSG game play by one or more players. This may include, for example:
Receiving Game Outcome/Result information from Game of Chance Engine 740. For example, as illustrated in the example embodiment of FIG. 7, PSG Game Play Components 720 may include PSG Control Engine 724 which may be configured or designed to receive the Game Outcome/Result information, and to use the Game Outcome/Result information to dynamically influence game play activity/event(s) using one or more PSG Control Mechanism(s) in order to achieve the identified Game Outcome 748 (e.g., as determined by the Game of Chance Engine 740) at end of current game or gaming session.
Receiving game related input from one or more players.
Enabling a player's input, timing, and/or skill to have a desired degree of impact or effect on that player's performance, achievement(s), and/or game event outcome(s).
Dynamically adjusting the amount of influence that a player's input (and/or game play activities) has on the current game being played.
Dynamically influencing game play activity/event(s) using one or more PSG Control Mechanism(s) in order to achieve the Game Outcome 748 (e.g., as determined by the Game of Chance Engine 740) at end of current game or gaming session.
Display game state information, including displaying the previously determined Game Outcome at the end of the current game.

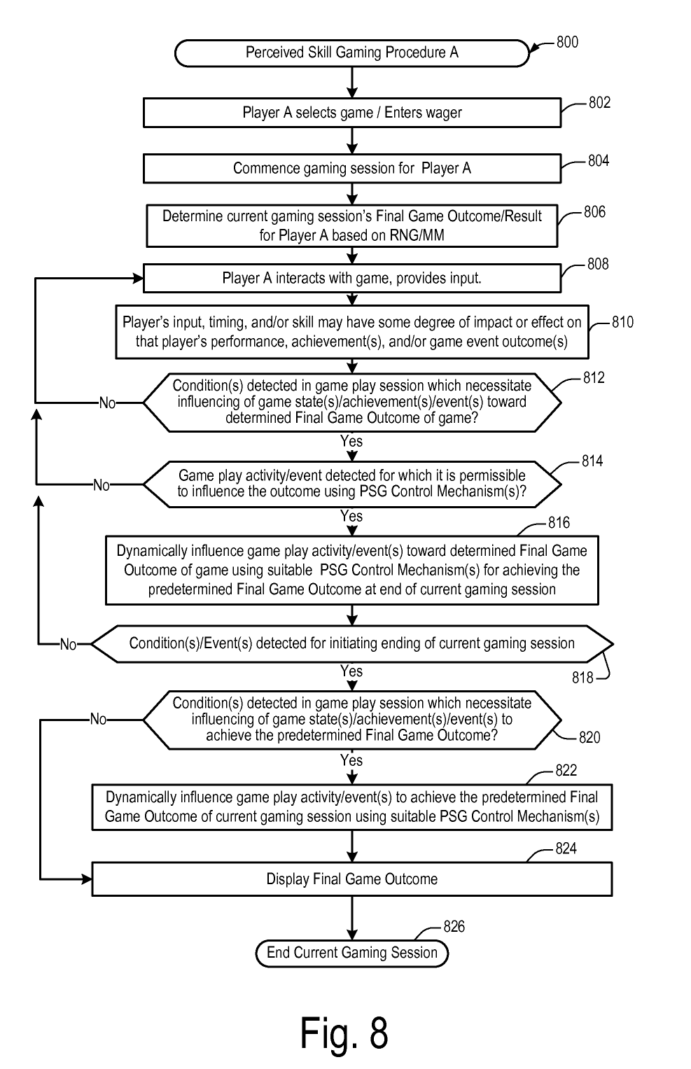

FIG. 8 shows a flow diagram of a Perceived Skill Gaming Procedure A 800 in accordance with a specific embodiment. According to different embodiments, at least a portion of the various types of functions, operations, actions, and/or other features provided by the Perceived Skill Gaming Procedure A may be implemented at one or more client systems(s), at one or more server systems (s), and/or combinations thereof. For example, in at least one embodiment, at least a portion of the various types of functions, operations, actions, and/or other features provided by the Perceived Skill Gaming Procedure A may be implemented at the Perceived Skill Game System of FIG. 7.

Purposes of illustration and clarity, the Perceived Skill Gaming Procedure of FIG. 8 is described with respect to a specifically identified player (Player A) who is participating in a PSG gaming session relating to a specific PSG game. In some embodiments, the PSG game may be configured as a single player game, while in other embodiments, the PSG game may be configured as a multiplayer game. Additionally, according to different embodiments, multiple instances or threads of the Perceived Skill Gaming Procedure may be concurrently implemented and/or initiated via the use of one or more processors and/or other combinations of hardware and/or hardware and software. For example, in at least some multiplayer PSG game embodiments, a separate instance or thread of the Perceived Skill Gaming Procedure may be concurrently implemented for each respective player who is participating in the current gaming session.

As illustrated in the example embodiment of FIG. 8, at 802, Player A may provide input regarding a selected PSG game to be played by Player A, and Player A's wager information.

As shown at 804, the PSG gaming session for Player A may start or commence.

As shown at 806, the Player A's Final Game Outcome/Result may be determined for the current gaming session. For example, in at least one embodiment, before actual game play by Player A commences, a request may be made to the GoC Engine (e.g., 740) to determine the Player A's final Game Outcome/Result for the current gaming session. In at least one embodiment, the determined final Game Outcome information may be provided to the PSG Control Engine, and used to dynamically influence game play activity/event(s) using one or more PSG Control Mechanism(s) in order to achieve the identified final Game Outcome for Player A at end of current game or gaming session. However, as mentioned previously, the Player is not made aware that the final game outcome (and/or one or more game event outcome(s)) has been predetermined and/or is not made aware that the final game outcome (and/or one or more game event outcome(s)) is based only on randomness, and may be unaffected by the player's game play input and/or actions.

As shown at 808, Player A engages in PSG game play, interacts with the PSG game, and provides game play input.

As shown at 810, during at least a portion of PSG game play, the player's input, timing, and/or skill may be allowed to have some degree of impact or effect on that player's performance, achievement(s), and/or game event outcome(s). Further, in at least some embodiments, the amount of influence that a player's input may have on that player's performance, achievement(s), and/or game event outcome(s) may be automatically and dynamically adjusted during PSG game play so that the identified final Game Outcome for that particular player/gaming session may be achieved at end of the gaming session.

As illustrated in the example embodiment of FIG. 8, at 812 a determination may be made as to whether or not a first set of condition(s) and/or event(s) has been detected which necessitate influencing of game state(s)/achievement(s)/event(s) of the current gaming session toward the predetermined Final Game Outcome. Various examples of such condition(s) and/or event(s) may relate to one or more of the following (or combinations thereof):
End of game/gaming session is approaching (e.g., less than X seconds of game play remaining, where X may be a value between 1 sec-15 sec.).
Comparison of Player's current achievements to predicted model (based on identified Final Game Outcome) exceeds a predefined threshold value.
Comparison of Player's current game state to predicted model (based on identified Final Game Outcome) exceeds a predefined threshold value.
Estimated likelihood of not achieving identified Final Game Outcome based on current game state exceeds a predefined threshold value.
Estimated likelihood of achieving identified Final Game Outcome without use of PSG Control Mechanisms is below a predefined threshold value.
Player's current level of influence on game state(s)/achievement(s)/event(s) requires adjustment.
X percentage of total game play has elapsed (e.g., X=50%, 75%, 80%, 90%, etc.).
and/or other types of condition(s) and/or event(s) which may necessitate influencing of game state(s)/achievement(s)/event(s) using PSG Control Mechanism(s) for achieving determined Final Game Outcome at end of current gaming session.

If it is determined that one or more condition(s) and/or event(s) have been detected which necessitate influencing of game state(s)/achievement(s)/event(s) of the current gaming session toward the predetermined Final Game Outcome, then the Perceived Skill Gaming Procedure may take appropriate action to dynamically influence (816) game play activity/event(s) to achieve the predetermined Final Game Outcome at end of current gaming session using suitable or appropriate PSG Control Mechanism(s). Additionally, in at least one embodiment, the Perceived Skill Gaming Procedure may include additional functionality to ensure that the PSG Control Mechanism(s) are implemented during game play activities/event(s) in which it is permissible and/or effective to influence the game play activities/event(s) using PSG Control Mechanism(s).

According to different embodiments, the amount or degree of influence that the PSG Control Engine has on the current PSG game play activities/event(s) may dynamically vary over time and/or in response to one or more detected event(s)/conditions(s). For example, referring to the Monster Truck PSG Game example described above, the dynamic adjustment of the player's influence (e.g. dynamic adjustment of the influence attributable to the player's input) may be proportional to the progress of the race and the player's relative position in the race. Thus, for example, in one embodiment, during a first portion of the race, the PSG Control Engine may exert only a relatively minor amount of influence on the game play activities/event(s) so as to allow the player to occupy any of the positions 1, 2, 3, 4, 5, 6, 7. However, given that the player must occupy position 4 at the end of the race (the predetermined Final Game Outcome for that player), there may be a second portion of the race (e.g., at or near the ending of the race) in which the PSG Control Engine dynamically exerts a relatively substantial amount of influence on the game play activities/event(s) so as to cause the player be in 4^{th} place at the end of the race.

Accordingly, as illustrated in the example embodiment of FIG. 8, upon detecting (818) one or more condition(s)/event(s) for initiating (or indicating) the ending of current gaming session, the Perceived Skill Gaming Procedure may take action to determine (820) whether or not any condition(s) are detected in the current PSG game play session which necessitates influencing of game state(s)/achievement(s)/event(s) to achieve the predetermined Final Game Outcome. For example, referring to the Monster Truck PSG Game example, during the last lap of the race, the Perceived Skill Gaming Procedure may determine and/or continuously monitor the current position of the player in the race, and if it is determined that the player is not in position 4, the Perceived Skill Gaming Procedure may determine that it is necessary to use PSG Control Mechanism(s) to achieve the predetermined Final Game Outcome by the end of the race.

Accordingly, as shown at 822, the PSG Control Engine may dynamically influence game play activity/event(s) to achieve and display (824) the predetermined Final Game Outcome at the end of the current gaming session (e.g., to cause the player to come in 4^{th} place at the end of the race) using suitable PSG Control Mechanism(s).

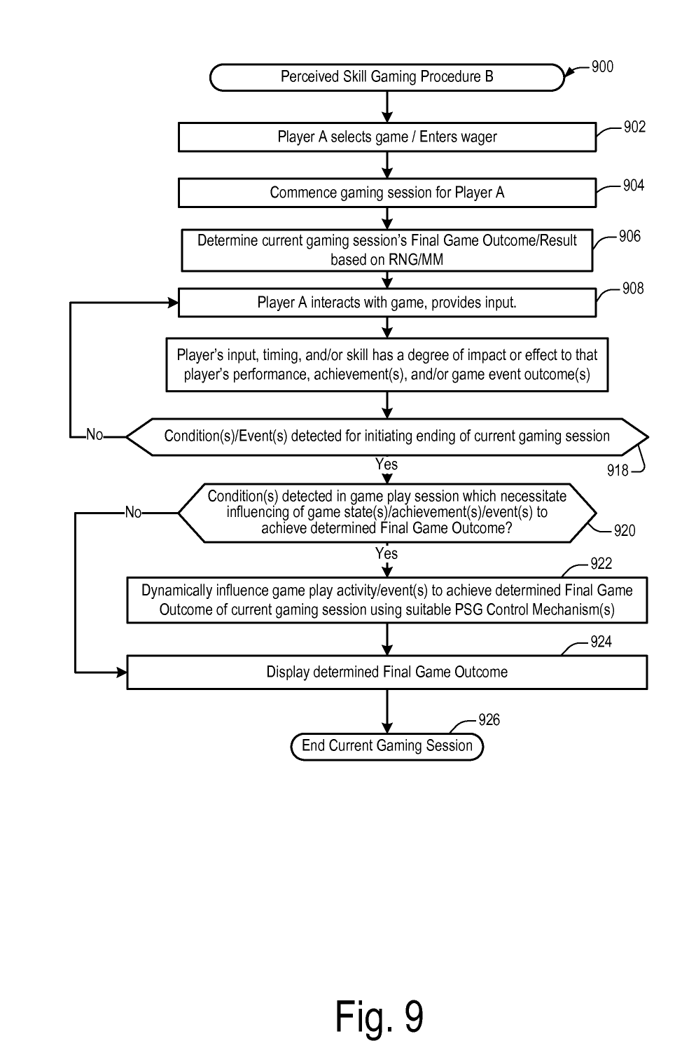

FIG. 9 shows a flow diagram of a Perceived Skill Gaming Procedure B 900 in accordance with a an alternate embodiment. It is noted that a substantial portion of the operations illustrated in the flow diagram of FIG. 9 are similar to those shown in FIG. 8 (with some of the operations of FIG. 8 being omitted in FIG. 9). Accordingly, the various operations illustrated in the example embodiment of FIG. 9 will not be described in greater detail, since FIG. 8 already provides a detailed description of these operations.

Various aspects described or referenced herein are directed to different methods, systems, and computer program products for facilitating implementation and use of perceived skill gaming techniques for controlling game event influence and/or game outcomes in gaming environments, including multi-player gaming environments.

Various examples of multi-player games and/or multi-player gaming environments may include, but are not limited to, one or more of the following (or combinations thereof):
internet-based multi-player online (MMO) games such as, for example, World of Warcraft™ (www.worldofwarcraft.com), The Sims Online™ (www.thesims.com), etc.
multi-player games accessible via consumer-type game consoles such as Microsoft XBOX™ Sony Playstation™, Nintendo WII™, etc.
multi-player wager-based games of chance accessible via one or more casino gaming networks and/or other types of gaming networks;
and/or other types of multi-player games which may be accessible to users/players via one or more other types of systems and/or networks.

According to different embodiments, one or more multi-player type games may be configured or designed to include event influence/outcome functionality for enabling one or more of the game event influence/outcome features and/or aspects described herein. For example, in one embodiment, the MMO game World of Warcraft™ may be configured or designed to include event influence/outcome functionality for facilitating implementation and use of perceived skill gaming techniques for controlling game event influence and/or game outcomes in gaming environments.

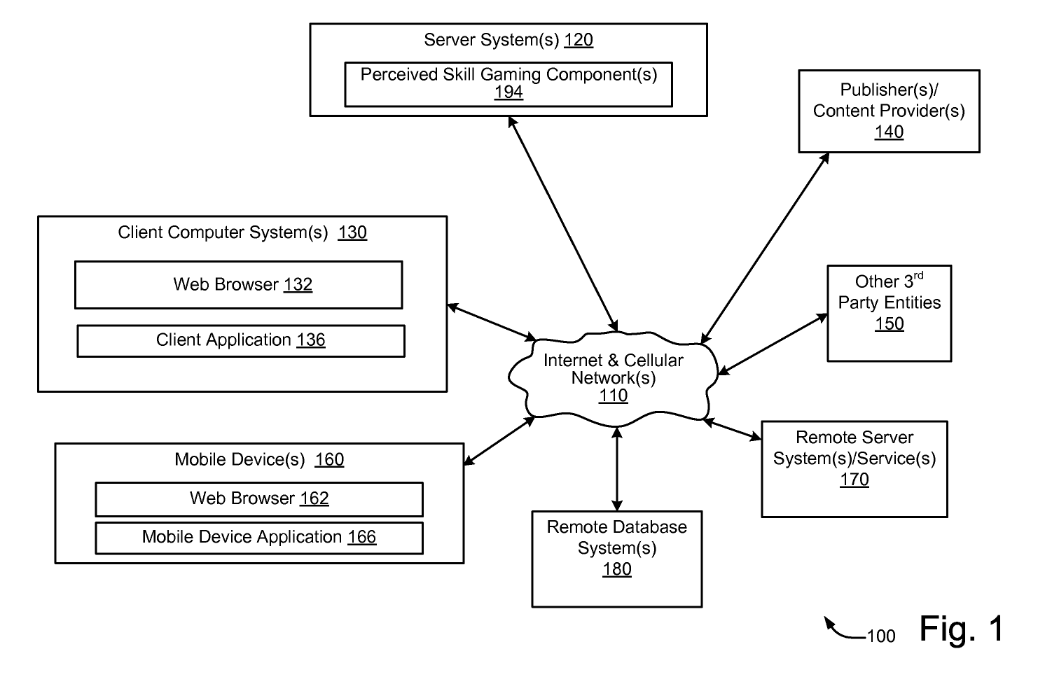

FIG. 1 illustrates a simplified block diagram of a specific example embodiment of a portion of a Gaming Network 100. As described in greater detail herein, different embodiments of computer networks may be configured, designed, and/or operable to provide various different types of operations, functionalities, and/or features generally relating to game event influence/outcome technology. Further, as described in greater detail herein, many of the various operations, functionalities, and/or features of the Gaming Network(s) disclosed herein may provide may enable or provide different types of advantages and/or benefits to different entities interacting with the Gaming Network(s).

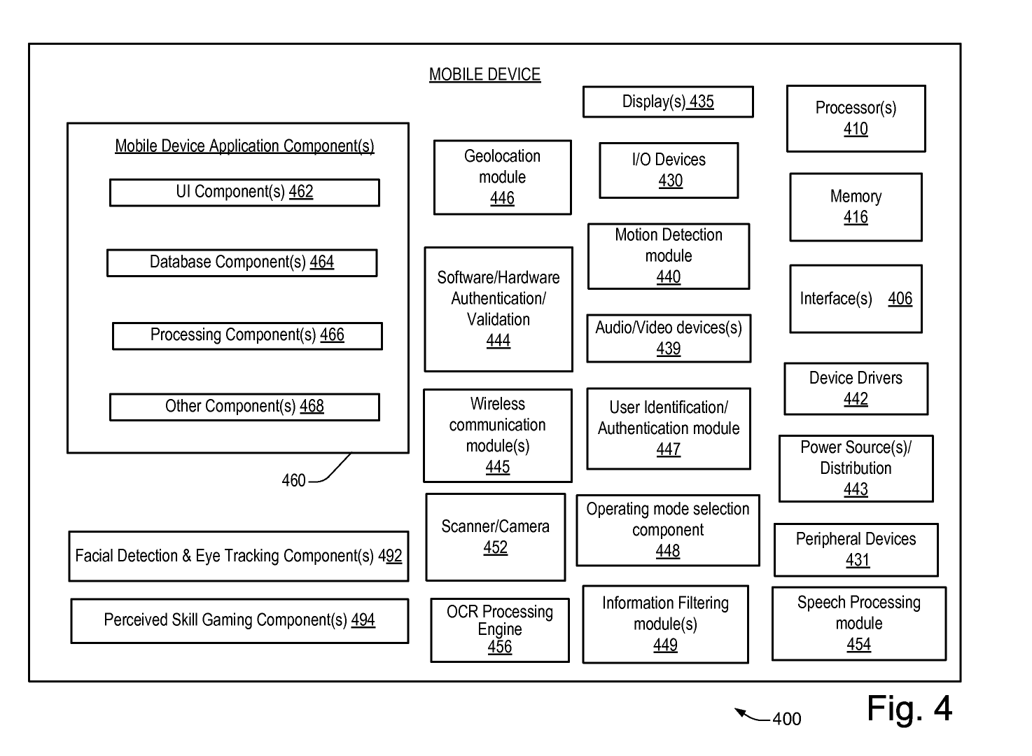

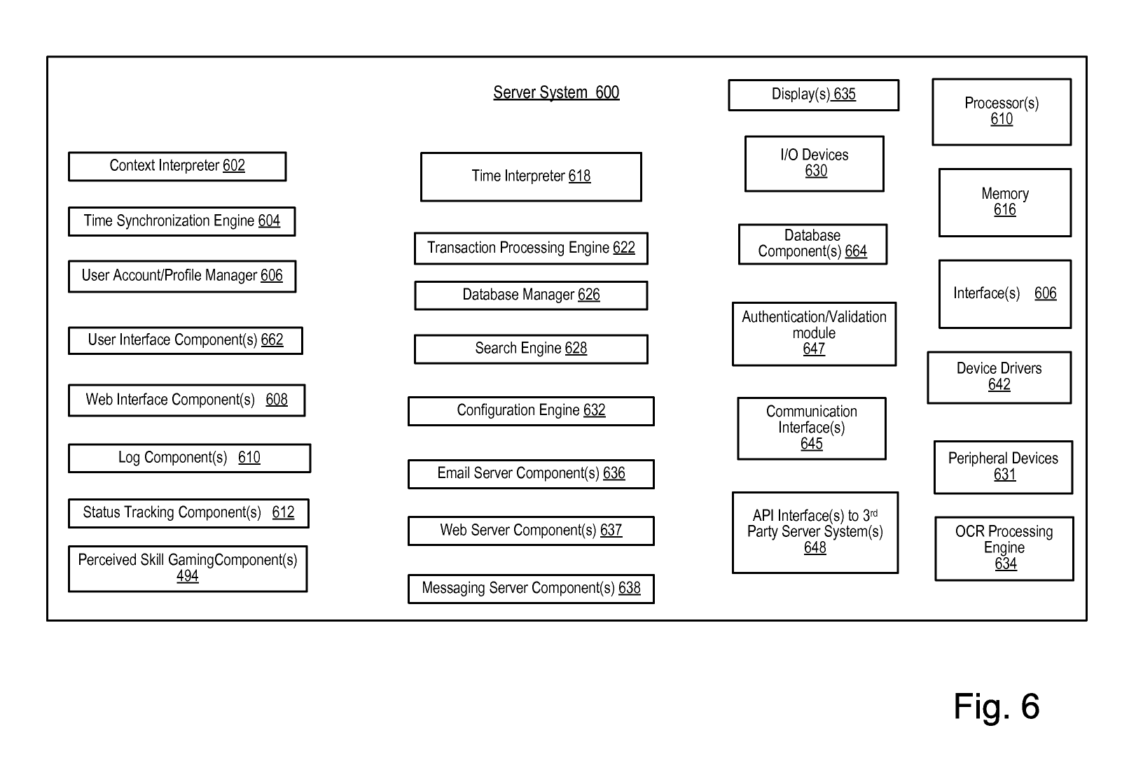

According to different embodiments, the Gaming Network 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the Gaming Network 100 may include one or more of the following types of systems, components, devices, processes, etc. (or combinations thereof):
Server System(s) 120—In at least one embodiment, the Server System(s) may be operable to perform and/or implement various types of functions, operations, actions, and/or other features such as those described or referenced herein (e.g., such as those illustrated and/or described with respect to FIG. 6). In at least one embodiment, Server System 120 may be configured or designed to include Perceived Skill Gaming Component(s) 194 for providing functionality relating to one or more of the perceived skill gaming techniques disclosed herein.
Publisher/Content Provider System component(s) 140
Client Computer System (s) 130
3^{rd} Party System(s) 150
Internet & Cellular Network(s) 110
Remote Database System(s)180
Remote Server System(s)/Service(s) 170, which, for example, may include, but are not limited to, one or more of the following (or combinations thereof):
   Content provider servers/services
   Media Streaming servers/services
   Database storage/access/query servers/services
   Financial transaction servers/services
   Payment gateway servers/services
   Electronic commerce servers/services
   Event management/scheduling servers/services
   Etc.
Mobile Device(s) 160, which, for example, may include, but are not limited to, one or more of the following (or combinations thereof): gaming machines, vending machines, televisions, kiosks, consumer devices, smart phones, video game consoles, personal computer systems, electronic display systems, etc. In at least one embodiment, the Mobile Device(s) may be operable to perform and/or implement various types of functions, operations, actions, and/or other features such as those described or referenced herein (e.g., such as those illustrated and/or described with respect to FIG. 4).
etc.

In at least one embodiment, a Mobile Device may be operable to detect gross motion or gross movement of a user. For example, in one embodiment, a Mobile Device may include motion detection component(s) which may be operable to detect gross motion or gross movement of a user's body and/or appendages such as, for example, hands, fingers, arms, head, etc.

According to different embodiments, at least some Gaming Network(s) may be configured, designed, and/or operable to provide a number of different advantages and/or benefits and/or may be operable to initiate, and/or enable various different types of operations, functionalities, and/or features, such as, for example, one or more of those described or referenced herein.

According to different embodiments, at least a portion of the various types of functions, operations, actions, and/or other features provided by the Gaming Network 100 may be implemented at one or more client systems(s), at one or more server systems (s), and/or combinations thereof.

According to different embodiments, the Gaming Network may be operable to utilize and/or generate various different types of data and/or other types of information when performing specific tasks and/or operations. This may include, for example, input data/information and/or output data/information. For example, in at least one embodiment, the Gaming Network may be operable to access, process, and/or otherwise utilize information from one or more different types of sources, such as, for example, one or more local and/or remote memories, devices and/or systems. Additionally, in at least one embodiment, the Gaming Network may be operable to generate one or more different types of output data/information, which, for example, may be stored in memory of one or more local and/or remote devices and/or systems. Examples of different types of input data/information and/or output data/information which may be accessed and/or utilized by the Gaming Network may include, but are not limited to, one or more of those described and/or referenced herein.

According to specific embodiments, multiple instances or threads of the Gaming Network may be concurrently implemented and/or initiated via the use of one or more processors and/or other combinations of hardware and/or hardware and software. For example, in at least some embodiments, various aspects, features, and/or functionalities of the Gaming Network may be performed, implemented and/or initiated by one or more of the various systems, components, systems, devices, procedures, processes, etc., described and/or referenced herein.

In at least one embodiment, a given instance of the Gaming Network may access and/or utilize information from one or more associated databases. In at least one embodiment, at least a portion of the database information may be accessed via communication with one or more local and/or remote memory devices. Examples of different types of data which may be accessed by the Gaming Network may include, but are not limited to, one or more of those described and/or referenced herein.

According to different embodiments, one or more different threads or instances of the Gaming Network may be initiated in response to detection of one or more conditions or events satisfying one or more different types of minimum threshold criteria for triggering initiation of at least one instance of the Gaming Network. Various examples of conditions or events which may trigger initiation and/or implementation of one or more different threads or instances of the Gaming Network may include, but are not limited to, one or more of those described and/or referenced herein.

It will be appreciated that the Gaming Network of FIG. 1 is but one example from a wide range of Gaming Network embodiments which may be implemented. Other embodiments of the Gaming Network (not shown) may include additional, fewer and/or different components/features that those illustrated in the example Gaming Network embodiment of FIG. 1.

Generally, the game event influence/outcome techniques described herein may be implemented in hardware and/or hardware+software. For example, they can be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

Hardware and/or software+hardware hybrid embodiments of the game event influence/outcome techniques described herein may be implemented on a general-purpose programmable machine selectively activated or reconfigured by a computer program stored in memory. Such programmable machine may include, for example, mobile or handheld computing systems, PDA, smart phones, notebook computers, tablets, netbooks, desktop computing systems, server systems, cloud computing systems, network devices, etc.

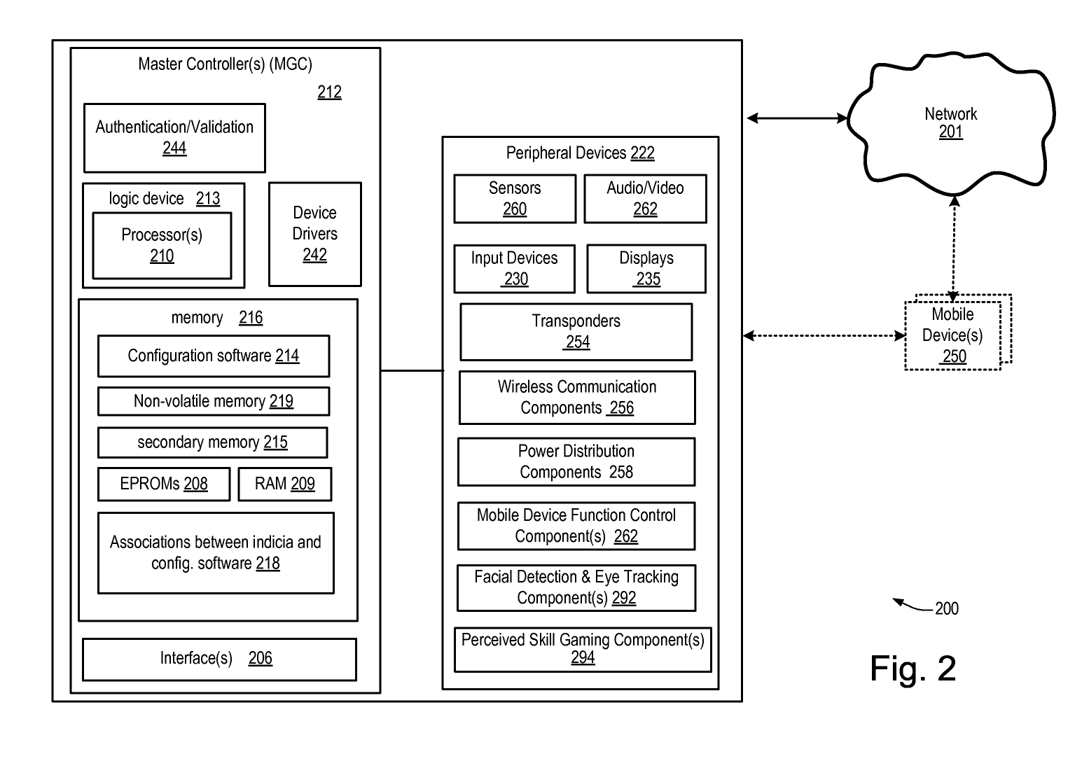

FIG. 2 is a simplified block diagram of an exemplary gaming machine 200 in accordance with a specific embodiment. As illustrated in the embodiment of FIG. 2, gaming machine 200 includes at least one processor 210, at least one interface 206, and memory 216.

In one implementation, processor 210 and master game controller 212 are included in a logic device 213 enclosed in a logic device housing. The processor 210 may include any conventional processor or logic device configured to execute software allowing various configuration and reconfiguration tasks such as, for example: a) communicating with a remote source via communication interface 206, such as a server that stores authentication information or games; b) converting signals read by an interface to a format corresponding to that used by software or memory in the gaming machine; c) accessing memory to configure or reconfigure game parameters in the memory according to indicia read from the device; d) communicating with interfaces, various peripheral devices 222 and/or I/O devices; e) operating peripheral devices 222 such as, for example, card readers, paper ticket readers, etc.; f) operating various I/O devices such as, for example, displays 235, input devices 230; etc. For instance, the processor 210 may send messages including game play information to the displays 235 to inform players of cards dealt, wagering information, and/or other desired information.

The gaming machine 200 also includes memory 216 which may include, for example, volatile memory (e.g., RAM 209), non-volatile memory 219 (e.g., disk memory, FLASH memory, EPROMs, etc.), unalterable memory (e.g., EPROMs 208), etc. The memory may be configured or designed to store, for example: 1) configuration software 214 such as all the parameters and settings for a game playable on the gaming machine; 2) associations 218 between configuration indicia read from a device with one or more parameters and settings; 3) communication protocols allowing the processor 210 to communicate with peripheral devices 222 and I/O devices 211; 4) a secondary memory storage device 215 such as a non-volatile memory device, configured to store gaming software related information (the gaming software related information and memory may be used to store various audio files and games not currently being used and invoked in a configuration or reconfiguration); 5) communication transport protocols (such as, for example, TCP/IP, USB, Firewire, IEEE1394, Bluetooth, IEEE 802.11x (IEEE 802.11 standards), hiperlan/2, HomeRF, etc.) for allowing the gaming machine to communicate with local and non-local devices using such protocols; etc. In one implementation, the master game controller 212 communicates using a serial communication protocol. A few examples of serial communication protocols that may be used to communicate with the master game controller include but are not limited to USB, RS-232 and Netplex (a proprietary protocol developed by IGT, Reno, Nev.).

A plurality of device drivers 242 may be stored in memory 216. Example of different types of device drivers may include device drivers for gaming machine components, device drivers for peripheral components 222, etc. Typically, the device drivers 242 utilize a communication protocol of some type that enables communication with a particular physical device. The device driver abstracts the hardware implementation of a device. For example, a device drive may be written for each type of card reader that may be potentially connected to the gaming machine. Examples of communication protocols used to implement the device drivers include Netplex, USB, Serial, Ethernet 275, Firewire, I/O debouncer, direct memory map, serial, PCI, parallel, RF, Bluetooth™, near-field communications (e.g., using near-field magnetics), 802.11 (WiFi), etc. Netplex is a proprietary IGT standard while the others are open standards. According to a specific embodiment, when one type of a particular device is exchanged for another type of the particular device, a new device driver may be loaded from the memory 216 by the processor 210 to allow communication with the device. For instance, one type of card reader in gaming machine 200 may be replaced with a second type of card reader where device drivers for both card readers are stored in the memory 216.

In some embodiments, the software units stored in the memory 216 may be upgraded as needed. For instance, when the memory 216 is a hard drive, new games, game options, various new parameters, new settings for existing parameters, new settings for new parameters, device drivers, and new communication protocols may be uploaded to the memory from the master game controller 212 or from some other external device. As another example, when the memory 216 includes a CD/DVD drive including a CD/DVD designed or configured to store game options, parameters, and settings, the software stored in the memory may be upgraded by replacing a first CD/DVD with a second CD/DVD. In yet another example, when the memory 216 uses one or more flash memory 219 or EPROM 208 units designed or configured to store games, game options, parameters, settings, the software stored in the flash and/or EPROM memory units may be upgraded by replacing one or more memory units with new memory units which include the upgraded software. In another embodiment, one or more of the memory devices, such as the hard-drive, may be employed in a game software download process from a remote software server.

In some embodiments, the gaming machine 200 may also include various authentication and/or validation components 244 which may be used for authenticating/validating specified gaming machine components such as, for example, hardware components, software components, firmware components, information stored in the gaming machine memory 216, etc. Examples of various authentication and/or validation components are described in U.S. Pat. No. 6,620,047, titled, “ELECTRONIC GAMING APPARATUS HAVING AUTHENTICATION DATA SETS,” incorporated herein by reference in its entirety for all purposes.

Peripheral devices 222 may include several device interfaces such as, for example: transponders 254, wire/wireless power distribution components 258, input device(s) 230, sensors 260, audio and/or video devices 262 (e.g., cameras, speakers, etc.), transponders 254, wireless communication components 256, wireless power components 258, mobile device function control components 262, side wagering management components 264, etc.

Sensors 260 may include, for example, optical sensors, pressure sensors, RF sensors, Infrared sensors, image sensors, thermal sensors, biometric sensors, etc. Such sensors may be used for a variety of functions such as, for example detecting the presence and/or identity of various persons (e.g., players, casino employees, etc.), devices (e.g., mobile devices), and/or systems within a predetermined proximity to the gaming machine. In one implementation, at least a portion of the sensors 260 and/or input devices 230 may be implemented in the form of touch keys selected from a wide variety of commercially available touch keys used to provide electrical control signals. Alternatively, some of the touch keys may be implemented in another form which are touch sensors such as those provided by a touchscreen display. For example, in at least one implementation, the gaming machine player displays and/or mobile device displays may include input functionality for allowing players to provide desired information (e.g., game play instructions and/or other input) to the gaming machine, game table and/or other gaming system components using the touch keys and/or other player control sensors/buttons. Additionally, such input functionality may also be used for allowing players to provide input to other devices in the casino gaming network (such as, for example, player tracking systems, side wagering systems, etc.)

Wireless communication components 256 may include one or more communication interfaces having different architectures and utilizing a variety of protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetic communication protocols, etc. The communication links may transmit electrical, electromagnetic or optical signals which carry digital data streams or analog signals representing various types of information.

Power distribution components 258 may include, for example, components or devices which are operable for providing wired or wireless power to other devices. For example, in one implementation, the power distribution components 258 may include a magnetic induction system which is adapted to provide wireless power to one or more mobile devices near the gaming machine. In one implementation, a mobile device docking region may be provided which includes a power distribution component that is able to recharge a mobile device without requiring metal-to-metal contact.

In at least one embodiment, mobile device function control components 262 may be operable to control operating mode selection functionality, features, and/or components associated with one or more mobile devices (e.g., 250). In at least one embodiment, mobile device function control components 262 may be operable to remotely control and/or configure components of one or more mobile devices 250 based on various parameters and/or upon detection of specific events or conditions such as, for example: time of day, player activity levels; location of the mobile device; identity of mobile device user; user input; system override (e.g., emergency condition detected); proximity to other devices belonging to same group or association; proximity to specific objects, regions, zones, etc.

In at least one embodiment, side wagering management components 264 may be operable to manage side wagering activities associated with one or more side wager participants. Side wagering management components 264 may also be operable to manage or control side wagering functionality associated with one or more mobile devices 250. In accordance with at least one embodiment, side wagers may be associated with specific events in a wager-based game that is uncertain at the time the side wager is made. The events may also be associated with particular players, gaming devices (e.g., EGMs), game themes, bonuses, denominations, and/or paytables. In embodiments where the wager-based game is being played by multiple players, in one embodiment the side wagers may be made by participants who are not players of the game, and who are thus at least one level removed from the actual play of the game.

In instances where side wagers are made on events that depend at least in part on the skill of a particular player, it may be beneficial to provide observers (e.g., side wager participants) with information which is useful for determining whether a particular side wager should be placed, and/or for helping to determine the amount of such side wager. In at least one embodiment, side wagering management components 264 may be operable to manage and/or facilitate data access to player ratings, historical game play data, historical payout data, etc. For example, in one embodiment, a player rating for a player of the wager-based game may be computed based on historical data associated with past play of the wager-based game by that player in accordance with a pre-determined algorithms. The player rating for a particular player may be displayed to other players and/or observers, possibly at the option (or permission) of the player. By using player ratings in the consideration of making side wagers, decisions by observers to make side wagers on certain events need not be made completely at random. Player ratings may also be employed by the players themselves to aid them in determining potential opponents, for example.

Perceived Skill Gaming Component(s) 294 may be configured or designed to facilitate implementation and use of perceived skill gaming techniques for controlling game event influence and/or game outcomes in gaming environments. According to different embodiments, the Perceived Skill Gaming Component(s) may be configured or designed to include event influence/outcome functionality for facilitating implementation and use of perceived skill gaming techniques for controlling game event influence and/or game outcomes in gaming environments.

In other embodiments (not shown) other peripheral devices include: player tracking devices, card readers, bill validator/paper ticket readers, etc. Such devices may each comprise resources for handling and processing configuration indicia such as a microcontroller that converts voltage levels for one or more scanning devices to signals provided to processor 210. In one embodiment, application software for interfacing with peripheral devices 222 may store instructions (such as, for example, how to read indicia from a portable device) in a memory device such as, for example, non-volatile memory, hard drive or a flash memory.

In at least one implementation, the gaming machine may include card readers such as used with credit cards, or other identification code reading devices to allow or require player identification in connection with play of the card game and associated recording of game action. Such a user identification interface can be implemented in the form of a variety of magnetic card readers commercially available for reading a user-specific identification information. The user-specific information can be provided on specially constructed magnetic cards issued by a casino, or magnetically coded credit cards or debit cards frequently used with national credit organizations such as VISA™, MASTERCARD™, banks and/or other institutions.

The gaming machine may include other types of participant identification mechanisms which may use a fingerprint image, eye blood vessel image reader, or other suitable biological information to confirm identity of the user. Still further it is possible to provide such participant identification information by having the dealer manually code in the information in response to the player indicating his or her code name or real name. Such additional identification could also be used to confirm credit use of a smart card, transponder, and/or player's mobile device.

It will be apparent to those skilled in the art that other memory types, including various computer readable media, may be used for storing and executing program instructions pertaining to the operation EGMs described herein. Because such information and program instructions may be employed to implement the systems/methods described herein, example embodiments may relate to machine-readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Example embodiments may also be embodied in a carrier wave traveling over an appropriate medium such as airwaves, optical lines, electric lines, etc. Examples of program instructions include both machine code, such as produced by a compiler, and files including higher level code that may be executed by the computer using an interpreter.

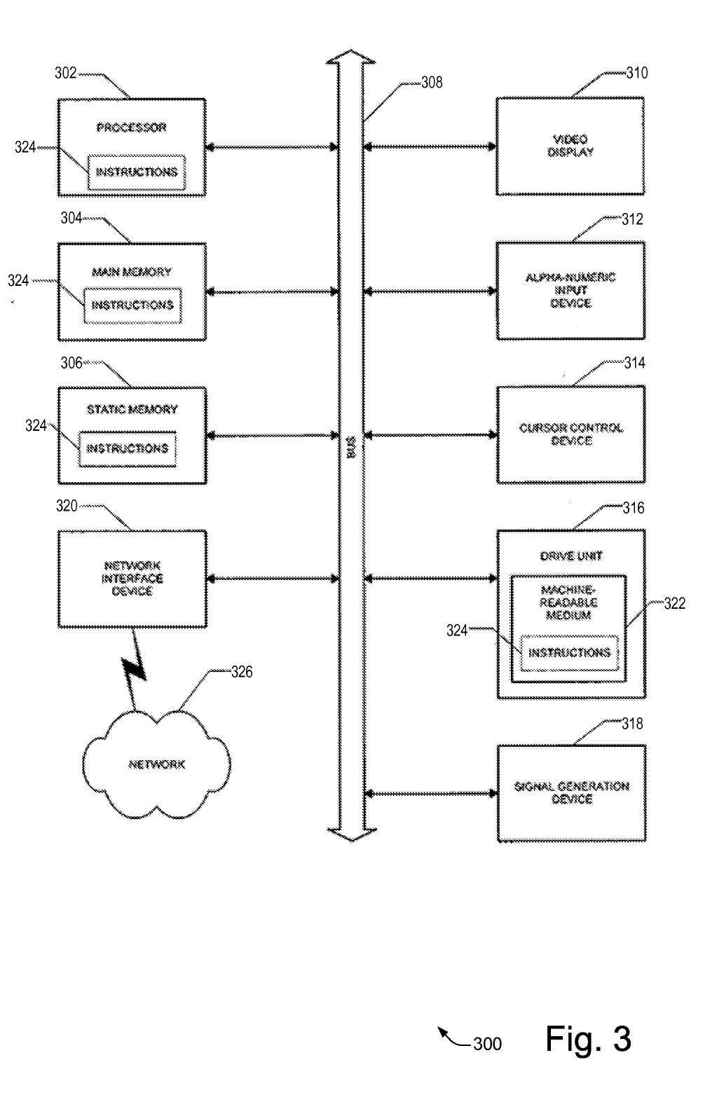

FIG. 3 shows a diagrammatic representation of machine in the exemplary form of a client (or end user) computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU), a graphics processing unit (GPU) or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an alphanumeric input device 312 (e.g., a keyboard), a user interface (UI) navigation device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions and data structures (e.g., software 324) embodying or utilized by any one or more of the methodologies or functions described herein. The software 324 may also reside, completely or at least partially, within the main memory 304 and/or within the processor 302 during execution thereof by the computer system 300, the main memory 304 and the processor 302 also constituting machine-readable media.

The software 324 may further be transmitted or received over a network 326 via the network interface device 320 utilizing any one of a number of well-known transfer protocols (e.g., HTTP).

While the machine-readable medium 322 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Although an embodiment of the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

According to various embodiments, Client Computer System 300 may include a variety of components, modules and/or systems for providing various types of functionality. For example, in at least one embodiment, Client Computer System 300 may include a web browser application which is operable to process, execute, and/or support the use of scripts (e.g., JavaScript, AJAX, etc.), Plug-ins, executable code, virtual machines, vector-based web animation (e.g., Adobe Flash), etc.

In at least one embodiment, the web browser application may be configured or designed to instantiate components and/or objects at the Client Computer System in response to processing scripts, instructions, and/or other information received from a remote server such as a web server. Examples of such components and/or objects may include, but are not limited to, one or more of the following (or combinations thereof):
UI Components such as those illustrated, described, and/or referenced herein.
Database Components such as those illustrated, described, and/or referenced herein.
Processing Components such as those illustrated, described, and/or referenced herein.
Other Components which, for example, may include components for facilitating and/or enabling the Client Computer System to perform and/or initiate various types of operations, activities, functions such as those described herein.

In at least one embodiment, Client Computer System 300 may be configured or designed to include Perceived Skill Gaming functionality for facilitating implementation and use of perceived skill gaming techniques for controlling game event influence and/or game outcomes in gaming environments.

According to different embodiments, the Perceived Skill Gaming functionality may be configured or designed to facilitate implementation and use of perceived skill gaming techniques for controlling game event influence and/or game outcomes in gaming environments.

FIG. 4 is a simplified block diagram of an exemplary Mobile Device 400 in accordance with a specific embodiment. In at least one embodiment, the Mobile Device may be configured or designed to include hardware components and/or hardware+software components for enabling or implementing at least a portion of the various game event influence/outcome techniques described and/or referenced herein.

According to specific embodiments, various aspects, features, and/or functionalities of the Mobile Device may be performed, implemented and/or initiated by one or more of the following types of systems, components, systems, devices, procedures, processes, etc. (or combinations thereof): Processor(s) 410; Device Drivers 442; Memory 416; Interface(s) 406; Power Source(s)/Distribution 443; Geolocation module 446; Display(s) 435; I/O Devices 430; Audio/Video devices(s) 439; Peripheral Devices 431; Motion Detection module 440; User Identification/Authentication module 447; Client App Component(s) 460; Other Component(s) 468; UI Component(s) 462; Database Component(s) 464; Processing Component(s) 466; Software/Hardware Authentication/Validation 444; Wireless communication module(s) 445; Information Filtering module(s) 449; Operating mode selection component 448; Speech Processing module 454; Scanner/Camera 452; OCR Processing Engine 456; Perceived Skill Gaming Component(s) 492; etc.

As illustrated in the example of FIG. 4, Mobile Device 400 may include a variety of components, modules and/or systems for providing various types of functionality. For example, as illustrated in FIG. 4, Mobile Device 400 may include Mobile Device Application components (e.g., 460), which, for example, may include, but are not limited to, one or more of the following (or combinations thereof):
UI Components 462 such as those illustrated, described, and/or referenced herein.
Database Components 464 such as those illustrated, described, and/or referenced herein.
Processing Components 466 such as those illustrated, described, and/or referenced herein.
Other Components 468 which, for example, may include components for facilitating and/or enabling the Mobile Device to perform and/or initiate various types of operations, activities, functions such as those described herein.

In at least one embodiment, the Mobile Device Application component(s) may be operable to perform and/or implement various types of functions, operations, actions, and/or other features such as, for example, one or more of those described and/or referenced herein.

According to specific embodiments, multiple instances or threads of the Mobile Device Application component(s) may be concurrently implemented and/or initiated via the use of one or more processors and/or other combinations of hardware and/or hardware and software. For example, in at least some embodiments, various aspects, features, and/or functionalities of the Mobile Device Application component(s) may be performed, implemented and/or initiated by one or more of the various systems, components, systems, devices, procedures, processes, etc., described and/or referenced herein.

According to different embodiments, one or more different threads or instances of the Mobile Device Application component(s) may be initiated in response to detection of one or more conditions or events satisfying one or more different types of minimum threshold criteria for triggering initiation of at least one instance of the Mobile Device Application component(s). Various examples of conditions or events which may trigger initiation and/or implementation of one or more different threads or instances of the Mobile Device Application component(s) may include, but are not limited to, one or more of those described and/or referenced herein.

In at least one embodiment, a given instance of the Mobile Device Application component(s) may access and/or utilize information from one or more associated databases. In at least one embodiment, at least a portion of the database information may be accessed via communication with one or more local and/or remote memory devices. Examples of different types of data which may be accessed by the Mobile Device Application component(s) may include, but are not limited to, one or more of those described and/or referenced herein.

According to different embodiments, Mobile Device 400 may further include, but is not limited to, one or more of the following types of components, modules and/or systems (or combinations thereof):
At least one processor 410. In at least one embodiment, the processor(s) 410 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 416, which, for example, may include volatile memory (e.g., RAM), non-volatile memory (e.g., disk memory, FLASH memory, EPROMs, etc.), unalterable memory, and/or other types of memory. In at least one implementation, the memory 416 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the client system and/or other information relating to the functionality of the various game event influence/outcome techniques described herein. The program instructions may control the operation of an operating system and/or one or more applications, for example. The memory or memories may also be configured to store data structures, metadata, timecode synchronization information, audio/visual media content, asset file information, keyword taxonomy information, advertisement information, and/or information/data relating to other features/functions described herein. Because such information and program instructions may be employed to implement at least a portion of the game event influence/outcome techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 406 which, for example, may include wired interfaces and/or wireless interfaces. In at least one implementation, the interface(s) 406 may include functionality similar to at least a portion of functionality implemented by one or more computer system interfaces such as those described herein and/or generally known to one having ordinary skill in the art. For example, in at least one implementation, the wireless communication interface(s) may be configured or designed to communicate with selected electronic game tables, computer systems, remote servers, other wireless devices (e.g., PDAs, cell phones, player tracking transponders, etc.), etc. Such wireless communication may be implemented using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Device driver(s) 442. In at least one implementation, the device driver(s) 442 may include functionality similar to at least a portion of functionality implemented by one or more computer system driver devices such as those described herein and/or generally known to one having ordinary skill in the art.
At least one power source (and/or power distribution source) 443. In at least one implementation, the power source may include at least one mobile power source (e.g., battery) for allowing the client system to operate in a wireless and/or mobile environment. For example, in one implementation, the power source 443 may be implemented using a rechargeable, thin-film type battery. Further, in embodiments where it is desirable for the device to be flexible, the power source 443 may be designed to be flexible.
Geolocation module 446 which, for example, may be configured or designed to acquire geolocation information from remote sources and use the acquired geolocation information to determine information relating to a relative and/or absolute position of the client system.
Motion detection component 440 for detecting motion or movement of the client system and/or for detecting motion, movement, gestures and/or other input data from user. In at least one embodiment, the motion detection component 440 may include one or more motion detection sensors such as, for example, MEMS (Micro Electro Mechanical System) accelerometers, that can detect the acceleration and/or other movements of the client system as it is moved by a user.
User Identification/Authentication module 447. In one implementation, the User Identification module may be adapted to determine and/or authenticate the identity of the current user or owner of the client system. For example, in one embodiment, the current Functionality for enabling a user to be required to perform a log in process at the client system in order to access one or more features. Alternatively, the client system may be adapted to automatically determine the identity of the current user based upon one or more external signals such as, for example, an RFID tag or badge worn by the current user which provides a wireless signal to the client system for determining the identity of the current user. In at least one implementation, various security features may be incorporated into the client system to prevent unauthorized users from accessing confidential or sensitive information.
One or more display(s) 435. According to various embodiments, such display(s) may be implemented using, for example, LCD display technology, OLED display technology, and/or other types of conventional display technology. In at least one implementation, display(s) 435 may be adapted to be flexible or bendable. Additionally, in at least one embodiment the information displayed on display(s) 435 may utilize e-ink technology (such as that available from E Ink Corporation, Cambridge, Mass., www.eink.com), or other suitable technology for reducing the power consumption of information displayed on the display(s) 435.
One or more user I/O Device(s) 430 such as, for example, keys, buttons, scroll wheels, cursors, touchscreen sensors, audio command interfaces, magnetic strip reader, optical scanner, etc.
Audio/Video device(s) 439 such as, for example, components for displaying audio/visual media which, for example, may include cameras, speakers, microphones, media presentation components, wireless transmitter/receiver devices for enabling wireless audio and/or visual communication between the client system 400 and remote devices (e.g., radios, telephones, computer systems, etc.). For example, in one implementation, the audio system may include componentry for enabling the client system to function as a cell phone or two-way radio device.
Other types of peripheral devices 431 which may be useful to the users of various client systems, such as, for example: PDA functionality; memory card reader(s); fingerprint reader(s); image projection device(s); social networking peripheral component(s); etc.
Information filtering module(s) 449 which, for example, may be adapted to automatically and dynamically generate, using one or more filter parameters, filtered information to be displayed on one or more displays of the mobile device. In one implementation, such filter parameters may be customizable by the player or user of the device. In some embodiments, information filtering module(s) 449 may also be adapted to display, in real-time, filtered information to the user based upon a variety of criteria such as, for example, geolocation information, casino data information, player tracking information, etc.
Wireless communication module(s) 445. In one implementation, the wireless communication module 445 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Software/Hardware Authentication/validation components 444 which, for example, may be used for authenticating and/or validating local hardware and/or software components, hardware/software components residing at a remote device, game play information, wager information, user information and/or identity, etc. Examples of various authentication and/or validation components are described in U.S. Pat. No. 6,620,047, titled, “ELECTRONIC GAMING APPARATUS HAVING AUTHENTICATION DATA SETS,” incorporated herein by reference in its entirety for all purposes.
Operating mode selection component 448 which, for example, may be operable to automatically select an appropriate mode of operation based on various parameters and/or upon detection of specific events or conditions such as, for example: the mobile device's current location; identity of current user; user input; system override (e.g., emergency condition detected); proximity to other devices belonging to same group or association; proximity to specific objects, regions, zones, etc. Additionally, the mobile device may be operable to automatically update or switch its current operating mode to the selected mode of operation. The mobile device may also be adapted to automatically modify accessibility of user-accessible features and/or information in response to the updating of its current mode of operation.
Scanner/Camera Component(s) (e.g., 452) which may be configured or designed for use in scanning identifiers and/or other content from other devices and/or objects such as for example: mobile device displays, computer displays, static displays (e.g., printed on tangible mediums), etc.
OCR Processing Engine (e.g., 456) which, for example, may be operable to perform image processing and optical character recognition of images such as those captured by a mobile device camera, for example.
Speech Processing module (e.g., 454) which, for example, may be operable to perform speech recognition, and may be operable to perform speech-to-text conversion.
Perceived Skill Gaming Component(s) 494 which may be configured or designed to facilitate implementation and use of perceived skill gaming techniques for controlling game event influence and/or game outcomes in gaming environments. According to different embodiments, the Perceived Skill Gaming Component(s) may be configured or designed to include event influence/outcome functionality for facilitating implementation and use of perceived skill gaming techniques for controlling game event influence and/or game outcomes in gaming environments.
Etc.

According to a specific embodiment, the Mobile Device may be adapted to implement at least a portion of the features associated with the mobile game service system described in U.S. patent application Ser. No. 10/115,164, which is now U.S. Pat. No. 6,800,029, issued Oct. 5, 2004, (previously incorporated by reference in its entirety). For example. in one embodiment, the Mobile Device may be comprised of a hand-held game service user interface device (GSUID) and a number of input and output devices. The GSUID is generally comprised of a display screen which may display a number of game service interfaces. These game service interfaces are generated on the display screen by a microprocessor of some type within the GSUID. Examples of a hand-held GSUID which may accommodate the game service interfaces are manufactured by Symbol Technologies, Incorporated of Holtsville, N.Y.

The game service interfaces may be used to provide a variety of game service transactions and gaming operations services. The game service interfaces, including a login interface, an input/output interface, a transaction reconciliation interface, a ticket validation interface, a prize services interfaces, a food services interface, an accommodation services interfaces, a gaming operations interfaces, a multi-game/multi-denomination meter data transfer interface, etc. Each interface may be accessed via a main menu with a number of sub-menus that allow a game service representative to access the different display screens relating to the particular interface. Using the different display screens within a particular interface, the game service representative may perform various operations needed to provide a particular game service. For example, the login interface may allow the game service representative to enter a user identification of some type and verify the user identification with a password. When the display screen is a touch screen, the user may enter the user/operator identification information on a display screen comprising the login interface using the input stylus and/or using the input buttons. Using a menu on the display screen of the login interface, the user may select other display screens relating to the login and registration process. For example, another display screen obtained via a menu on a display screen in the login interface may allow the GSUID to scan a finger print of the game service representative for identification purposes or scan the finger print of a game player.

The user identification information and user validation information may allow the game service representative to access all or some subset of the available game service interfaces available on the GSUID. For example, certain users, after logging into the GSUID (e.g. entering a user identification and a valid user identification information), may be able to access a variety of different interfaces, such as, for example, one or more of: input/output interface, communication interface, food services interface, accommodation services interface, prize service interface, gaming operation services interface, transaction reconciliation interface, voice communication interface, gaming device performance or metering data transfer interface, etc.; and perform a variety of services enabled by such interfaces. While other users may be only be able to access the award ticket validation interface and perform EZ pay ticket validations. The GSUID may also output game service transaction information to a number of different devices (e.g., card reader, printer, storage devices, gaming machines and remote transaction servers, etc.).

In addition to the features described above, various embodiments of mobile devices described herein may also include additional functionality for displaying, in real-time, filtered information to the user based upon a variety of criteria such as, for example, geolocation information, casino data information, player tracking information, etc.

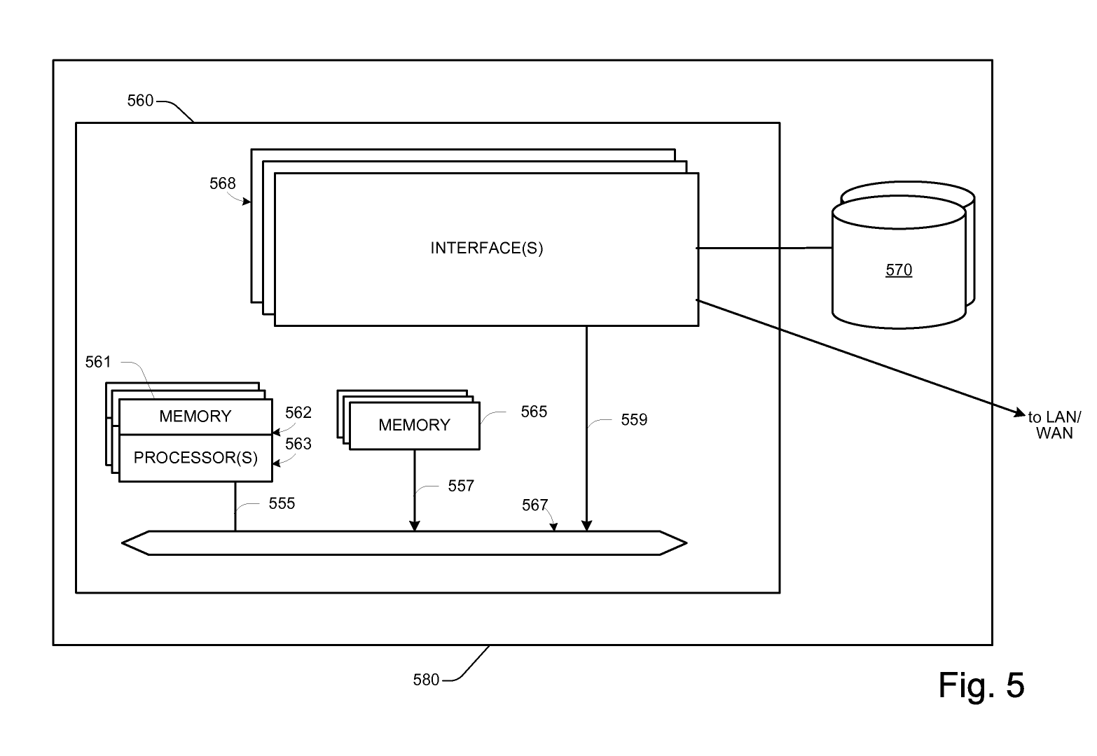

FIG. 5 illustrates an example embodiment of a Server System 580 which may be used for implementing various aspects/features described herein. In at least one embodiment, the Server System 580 includes at least one network device 560, and at least one storage device 570 (such as, for example, a direct attached storage device). In one embodiment, Server System 580 may be suitable for implementing at least some of the game event influence/outcome techniques described herein.

In according to one embodiment, network device 560 may include a master central processing unit (CPU) 562, interfaces 568, and a bus 567 (e.g., a PCI bus). When acting under the control of appropriate software or firmware, the CPU 562 may be responsible for implementing specific functions associated with the functions of a desired network device. For example, when configured as a server, the CPU 562 may be responsible for analyzing packets; encapsulating packets; forwarding packets to appropriate network devices; instantiating various types of virtual machines, virtual interfaces, virtual storage volumes, virtual appliances; etc. The CPU 562 preferably accomplishes at least a portion of these functions under the control of software including an operating system (e.g. Linux), and any appropriate system software (such as, for example, AppLogic™ software).

CPU 562 may include one or more processors 563 such as, for example, one or more processors from the AMD, Motorola, Intel and/or MIPS families of microprocessors. In an alternative embodiment, processor 563 may be specially designed hardware for controlling the operations of Server System 580. In a specific embodiment, a memory 561 (such as non-volatile RAM and/or ROM) also forms part of CPU 562. However, there may be many different ways in which memory could be coupled to the system. Memory block 561 may be used for a variety of purposes such as, for example, caching and/or storing data, programming instructions, etc.

The interfaces 568 may be typically provided as interface cards (sometimes referred to as “line cards”). Alternatively, one or more of the interfaces 568 may be provided as on-board interface controllers built into the system motherboard. Generally, they control the sending and receiving of data packets over the network and sometimes support other peripherals used with the Server System 580. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 3G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 562 to efficiently perform routing computations, network diagnostics, security functions, etc.

In at least one embodiment, some interfaces may be configured or designed to allow the Server System 580 to communicate with other network devices associated with various local area network (LANs) and/or wide area networks (WANs). Other interfaces may be configured or designed to allow network device 560 to communicate with one or more direct attached storage device(s) 570.

Although the system shown in FIG. 5 illustrates one specific network device described herein, it is by no means the only network device architecture on which one or more embodiments can be implemented. For example, an architecture having a single processor that handles communications as well as routing computations, etc. may be used. Further, other types of interfaces and media could also be used with the network device.

Regardless of network device's configuration, it may employ one or more memories or memory modules (such as, for example, memory block 565, which, for example, may include random access memory (RAM)) configured to store data, program instructions for the general-purpose network operations and/or other information relating to the functionality of the various game event influence/outcome techniques described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Some embodiments may also be embodied in transmission media such as, for example, a carrier wave travelling over an appropriate medium such as airwaves, optical lines, electric lines, etc. Examples of program instructions include both machine code, such as produced by a compiler, and files containing higher level code that may be executed by the computer using an interpreter.

FIG. 6 illustrates an example of a functional block diagram of a Server System 600 in accordance with a specific embodiment. In at least one embodiment, the Server System 600 may be operable to perform and/or implement various types of functions, operations, actions, and/or other features such, for example, one or more of those illustrated, described, and/or referenced herein.

In at least one embodiment, the Server System may include a plurality of components operable to perform and/or implement various types of functions, operations, actions, and/or other features such as, for example, one or more of the following (or combinations thereof):
Context Interpreter (e.g., 602) which, for example, may be operable to automatically and/or dynamically analyze contextual criteria relating to one or more detected event(s) and/or condition(s), and automatically determine or identify one or more contextually appropriate response(s) based on the contextual interpretation of the detected event(s)/condition(s). According to different embodiments, examples of contextual criteria which may be analyzed may include, but are not limited to, one or more of the following (or combinations thereof): location-based criteria (e.g., geolocation of client device, geolocation of agent device, etc.); time-based criteria; identity of Client user; identity of Agent user; user profile information; transaction history information; recent user activities; proximate business-related criteria (e.g., criteria which may be used to determine whether the client device is currently located at or near a recognized business establishment such as a bank, gas station, restaurant, supermarket, etc.); etc.
Time Synchronization Engine (e.g., 604) which, for example, may be operable to manages universal time synchronization (e.g., via NTP and/or GPS)
Search Engine (e.g., 628) which, for example, may be operable to search for transactions, logs, items, accounts, options in the TIS databases
Configuration Engine (e.g., 632) which, for example, may be operable to determine and handle configuration of various customized configuration parameters for one or more devices, component(s), system(s), process(es), etc.
Time Interpreter (e.g., 618) which, for example, may be operable to automatically and/or dynamically modify or change identifier activation and expiration time(s) based on various criteria such as, for example, time, location, transaction status, etc.
Authentication/Validation Component(s) (e.g., 647) (password, software/hardware info, SSL certificates) which, for example, may be operable to perform various types of authentication/validation tasks such as, for example, one or more of the following (or combinations thereof): verifying/authenticating devices; verifying passwords, passcodes, SSL certificates, biometric identification information, and/or other types of security-related information; verify/validate activation and/or expiration times; etc. In one implementation, the Authentication/Validation Component(s) may be adapted to determine and/or authenticate the identity of the current user or owner of the mobile client system. For example, in one embodiment, the current user may be required to perform a log in process at the mobile client system in order to access one or more features. In some embodiments, the mobile client system may include biometric security components which may be operable to validate and/or authenticate the identity of a user by reading or scanning The user's biometric information (e.g., fingerprints, face, voice, eye/iris, etc.). In at least one implementation, various security features may be incorporated into the mobile client system to prevent unauthorized users from accessing confidential or sensitive information.
Transaction Processing Engine (e.g., 622) which, for example, may be operable to handle various types of transaction processing tasks such as, for example, one or more of the following (or combinations thereof): identifying/determining transaction type; determining which payment gateway(s) to use; associating databases information to identifiers; etc.
OCR Processing Engine (e.g., 634) which, for example, may be operable to perform image processing and optical character recognition of images such as those captured by a mobile device camera, for example.
Database Manager (e.g., 626) which, for example, may be operable to handle various types of tasks relating to database updating, database management, database access, etc. In at least one embodiment, the Database Manager may be operable to manage TISS databases, Gaming Device Application databases, etc.
Log Component(s) (e.g., 610) which, for example, may be operable to generate and manage transactions history logs, system errors, connections from APIs, etc.
Status Tracking Component(s) (e.g., 612) which, for example, may be operable to automatically and/or dynamically determine, assign, and/or report updated transaction status information based, for example, on the state of the transaction. In at least one embodiment, the status of a given transaction may be reported as one or more of the following (or combinations thereof): Completed, Incomplete, Pending, Invalid, Error, Declined, Accepted, etc.
Gateway Component(s) (e.g., 614) which, for example, may be operable to facilitate and manage communications and transactions with external Payment Gateways.
Web Interface Component(s) (e.g., 608) which, for example, may be operable to facilitate and manage communications and transactions with TIS web portal(s).
API Interface(s) to Server System(s) (e.g., 646) which, for example, may be operable to facilitate and manage communications and transactions with API Interface(s) to Server System(s)
API Interface(s) to 3rd Party Server System(s) (e.g., 648) which, for example, may be operable to facilitate and manage communications and transactions with API Interface(s) to 3rd Party Server System(s)
OCR Processing Engine (e.g., 634) which, for example, may be operable to perform image processing and optical character recognition of images such as those captured by a mobile device camera, for example.
At least one processor 610. In at least one embodiment, the processor(s) 610 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the mobile client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 616, which, for example, may include volatile memory (e.g., RAM), non-volatile memory (e.g., disk memory, FLASH memory, EPROMs, etc.), unalterable memory, and/or other types of memory. In at least one implementation, the memory 616 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile client system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein. Because such information and program instructions may be employed to implement at least a portion of the Gaming Network techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 606 which, for example, may include wired interfaces and/or wireless interfaces. In at least one implementation, the interface(s) 606 may include functionality similar to at least a portion of functionality implemented by one or more computer system interfaces such as those described herein and/or generally known to one having ordinary skill in the art.
Device driver(s) 642. In at least one implementation, the device driver(s) 642 may include functionality similar to at least a portion of functionality implemented by one or more computer system driver devices such as those described herein and/or generally known to one having ordinary skill in the art.
One or more display(s) 635. According to various embodiments, such display(s) may be implemented using, for example, LCD display technology, OLED display technology, and/or other types of conventional display technology. In at least one implementation, display(s) 635 may be adapted to be flexible or bendable. Additionally, in at least one embodiment the information displayed on display(s) 635 may utilize e-ink technology (such as that available from E Ink Corporation, Cambridge, Mass., www.eink.com), or other suitable technology for reducing the power consumption of information displayed on the display(s) 635.
Email Server Component(s) 636, which, for example, may be configured or designed to provide various functions and operations relating to email activities and communications.
Web Server Component(s) 637, which, for example, may be configured or designed to provide various functions and operations relating to web server activities and communications.
Messaging Server Component(s) 638, which, for example, may be configured or designed to provide various functions and operations relating to text messaging and/or other social network messaging activities and/or communications.
Perceived Skill Gaming Component(s) 694 which may be configured or designed to facilitate implementation and use of perceived skill gaming techniques for controlling game event influence and/or game outcomes in gaming environments. According to different embodiments, the Perceived Skill Gaming Component(s) may be configured or designed to include event influence/outcome functionality for facilitating implementation and use of perceived skill gaming techniques for controlling game event influence and/or game outcomes in gaming environments.

According to different embodiments, at least a portion of the various types of functions, operations, actions, and/or other features provided by the perceived skill gaming techniques described and/or referenced herein may be implemented at one or more client systems(s), at one or more server systems (s), and/or combinations thereof.

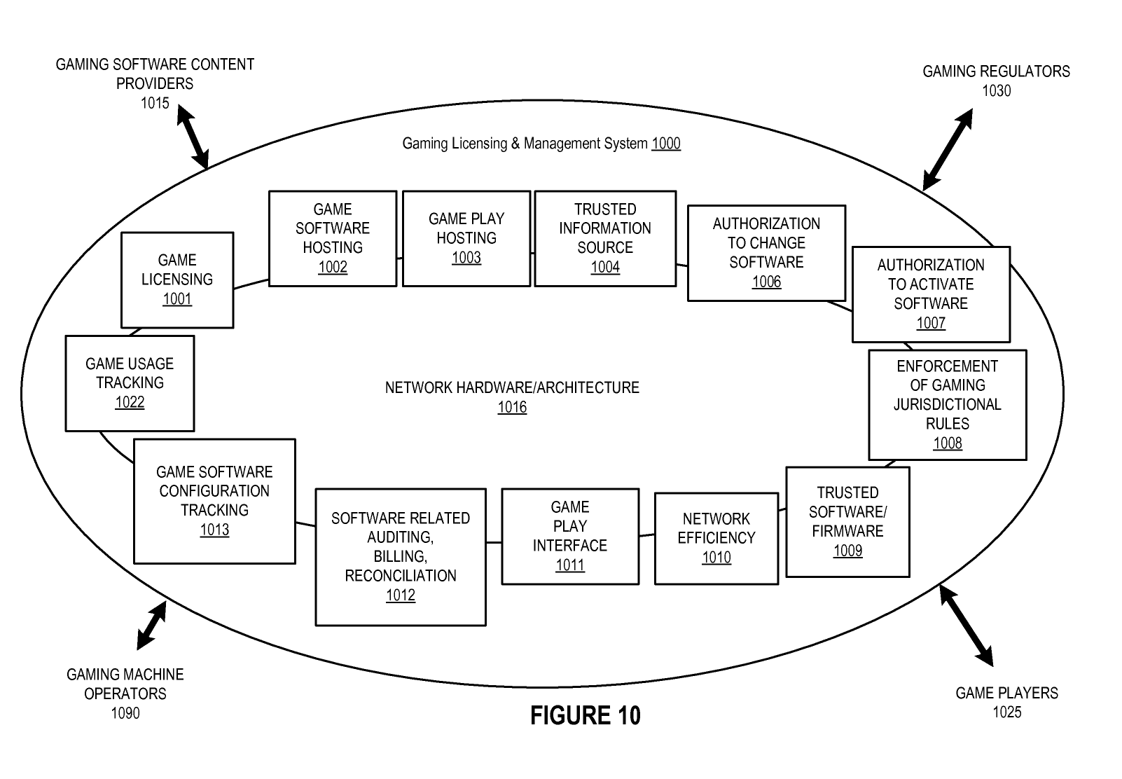

FIG. 10 shows a block diagram illustrating components of a gaming system 1000 which may be used for implementing various aspects of example embodiments. In FIG. 10, the components of a gaming system 1000 for providing game software licensing and downloads are described functionally. The described functions may be instantiated in hardware, firmware and/or software and executed on a suitable device. In the system 1000, there may be many instances of the same function, such as multiple game play interfaces 1011. Nevertheless, in FIG. 10, only one instance of each function is shown. The functions of the components may be combined. For example, a single device may comprise the game play interface 1011 and include trusted memory devices or sources 1009.

The gaming system 1000 may receive inputs from different groups/entities and output various services and or information to these groups/entities. For example, game players 1025 primarily input cash or indicia of credit into the system, make game selections that trigger software downloads, and receive entertainment in exchange for their inputs. Game software content providers provide game software for the system and may receive compensation for the content they provide based on licensing agreements with the gaming machine operators. Gaming machine operators select game software for distribution, distribute the game software on the gaming devices in the system 1000, receive revenue for the use of their software and compensate the gaming machine operators. The gaming regulators 1030 may provide rules and regulations that must be applied to the gaming system and may receive reports and other information confirming that rules are being obeyed.

In the following paragraphs, details of each component and some of the interactions between the components are described with respect to FIG. 10. The game software license host 1001 may be a server connected to a number of remote gaming devices that provides licensing services to the remote gaming devices. For example, in other embodiments, the license host 1001 may 1) receive token requests for tokens used to activate software executed on the remote gaming devices, 10) send tokens to the remote gaming devices, 3) track token usage and 4) grant and/or renew software licenses for software executed on the remote gaming devices. The token usage may be used in utility based licensing schemes, such as a pay-per-use scheme.

In another embodiment, a game usage-tracking host 1015 may track the usage of game software on a plurality of devices in communication with the host. The game usage-tracking host 1015 may be in communication with a plurality of game play hosts and gaming machines. From the game play hosts and gaming machines, the game usage tracking host 1015 may receive updates of an amount that each game available for play on the devices has been played and on amount that has been wagered per game. This information may be stored in a database and used for billing according to methods described in a utility based licensing agreement.

The game software host 1002 may provide game software downloads, such as downloads of game software or game firmware, to various devious in the game system 1000. For example, when the software to generate the game is not available on the game play interface 1011, the game software host 1002 may download software to generate a selected game of chance played on the game play interface. Further, the game software host 1002 may download new game content to a plurality of gaming machines via a request from a gaming machine operator.

In one embodiment, the game software host 1002 may also be a game software configuration-tracking host 1013. The function of the game software configuration-tracking host is to keep records of software configurations and/or hardware configurations for a plurality of devices in communication with the host (e.g., denominations, number of paylines, paytables, max/min wagers). Details of a game software host and a game software configuration host that may be used with example embodiments are described in co-pending U.S. Pat. No. 6,645,077, by Rowe, titled, “Gaming Terminal Data Repository and Information System,” which is incorporated herein in its entirety and for all purposes.

A game play host device 1003 may be a host server connected to a plurality of remote clients that generates games of chance that are displayed on a plurality of remote game play interfaces 1011. For example, the game play host device 1003 may be a server that provides central determination for a bingo game play played on a plurality of connected game play interfaces 1011. As another example, the game play host device 1003 may generate games of chance, such as slot games or video card games, for display on a remote client. A game player using the remote client may be able to select from a number of games that are provided on the client by the host device 1003. The game play host device 1003 may receive game software management services, such as receiving downloads of new game software, from the game software host 1002 and may receive game software licensing services, such as the granting or renewing of software licenses for software executed on the device 1003, from the game license host 1001.

In particular embodiments, the game play interfaces or other gaming devices in the gaming system 1000 may be portable devices, such as electronic tokens, cell phones, smart cards, tablet PC's and PDA's. The portable devices may support wireless communications and thus, may be referred to as wireless mobile devices. The network hardware architecture 1016 may be enabled to support communications between wireless mobile devices and other gaming devices in gaming system. In one embodiment, the wireless mobile devices may be used to play games of chance.

The gaming system 1000 may use a number of trusted information sources. Trusted information sources 1004 may be devices, such as servers, that provide information used to authenticate/activate other pieces of information. CRC values used to authenticate software, license tokens used to allow the use of software or product activation codes used to activate to software are examples of trusted information that might be provided from a trusted information source 1004. Trusted information sources may be a memory device, such as an EPROM, that includes trusted information used to authenticate other information. For example, a game play interface 1011 may store a private encryption key in a trusted memory device that is used in a private key-public key encryption scheme to authenticate information from another gaming device.

When a trusted information source 1004 is in communication with a remote device via a network, the remote device will employ a verification scheme to verify the identity of the trusted information source. For example, the trusted information source and the remote device may exchange information using public and private encryption keys to verify each other's identities. In another example of an embodiment, the remote device and the trusted information source may engage in methods using zero knowledge proofs to authenticate each of their respective identities. Details of zero knowledge proofs that may be used with example embodiments are described in US publication no. 2003/0203756, by Jackson, and titled, “Authentication in a Secure Computerized Gaming System”, which is incorporated herein in its entirety and for all purposes.

Gaming devices storing trusted information might utilize apparatus or methods to detect and prevent tampering. For instance, trusted information stored in a trusted memory device may be encrypted to prevent its misuse. In addition, the trusted memory device may be secured behind a locked door. Further, one or more sensors may be coupled to the memory device to detect tampering with the memory device and provide some record of the tampering. In yet another example, the memory device storing trusted information might be designed to detect tampering attempts and clear or erase itself when an attempt at tampering has been detected.

The gaming system 1000 of example embodiments may include devices 1006 that provide authorization to download software from a first device to a second device and devices 1007 that provide activation codes or information that allow downloaded software to be activated. The devices, 1006 and 1007, may be remote servers and may also be trusted information sources. One example of a method of providing product activation codes that may be used with example embodiments is describes in previously incorporated U.S. Pat. No. 6,264,561.

A device 1006 that monitors a plurality of gaming devices to determine adherence of the devices to gaming jurisdictional rules 1008 may be included in the system 1000. In one embodiment, a gaming jurisdictional rule server may scan software and the configurations of the software on a number of gaming devices in communication with the gaming rule server to determine whether the software on the gaming devices is valid for use in the gaming jurisdiction where the gaming device is located. For example, the gaming rule server may request a digital signature, such as CRC's, of particular software components and compare them with an approved digital signature value stored on the gaming jurisdictional rule server.

Further, the gaming jurisdictional rule server may scan the remote gaming device to determine whether the software is configured in a manner that is acceptable to the gaming jurisdiction where the gaming device is located. For example, a maximum wager limit may vary from jurisdiction to jurisdiction and the rule enforcement server may scan a gaming device to determine its current software configuration and its location and then compare the configuration on the gaming device with approved parameters for its location.

A gaming jurisdiction may include rules that describe how game software may be downloaded and licensed. The gaming jurisdictional rule server may scan download transaction records and licensing records on a gaming device to determine whether the download and licensing was carried out in a manner that is acceptable to the gaming jurisdiction in which the gaming device is located. In general, the game jurisdictional rule server may be utilized to confirm compliance to any gaming rules passed by a gaming jurisdiction when the information needed to determine rule compliance is remotely accessible to the server.

Game software, firmware or hardware residing a particular gaming device may also be used to check for compliance with local gaming jurisdictional rules. In one embodiment, when a gaming device is installed in a particular gaming jurisdiction, a software program including jurisdiction rule information may be downloaded to a secure memory location on a gaming machine or the jurisdiction rule information may be downloaded as data and utilized by a program on the gaming machine. The software program and/or jurisdiction rule information may be used to check the gaming device software and software configurations for compliance with local gaming jurisdictional rules. In another embodiment, the software program for ensuring compliance and jurisdictional information may be installed in the gaming machine prior to its shipping, such as at the factory where the gaming machine is manufactured.

The gaming devices in game system 1000 may utilize trusted software and/or trusted firmware. Trusted firmware/software is trusted in the sense that is used with the assumption that it has not been tampered with. For instance, trusted software/firmware may be used to authenticate other game software or processes executing on a gaming device. As an example, trusted encryption programs and authentication programs may be stored on an EPROM on the gaming machine or encoded into a specialized encryption chip. As another example, trusted game software, i.e., game software approved for use on gaming devices by a local gaming jurisdiction may be required on gaming devices on the gaming machine.

In example embodiments, the devices may be connected by a network 1016 with different types of hardware using different hardware architectures. Game software can be quite large and frequent downloads can place a significant burden on a network, which may slow information transfer speeds on the network. For game-on-demand services that require frequent downloads of game software in a network, efficient downloading is essential for the service to viable. Thus, in example embodiments, network efficient devices 1010 may be used to actively monitor and maintain network efficiency. For instance, software locators may be used to locate nearby locations of game software for peer-to-peer transfers of game software. In another example, network traffic may be monitored and downloads may be actively rerouted to maintain network efficiency.

One or more devices in example embodiments may provide game software and game licensing related auditing, billing and reconciliation reports to server 1012. For example, a software licensing billing server may generate a bill for a gaming device operator based upon a usage of games over a time period on the gaming devices owned by the operator. In another example, a software auditing server may provide reports on game software downloads to various gaming devices in the gaming system 1000 and current configurations of the game software on these gaming devices.

At particular time intervals, the software auditing server 1012 may also request software configurations from a number of gaming devices in the gaming system. The server may then reconcile the software configuration on each gaming device. In one embodiment, the software auditing server 1012 may store a record of software configurations on each gaming device at particular times and a record of software download transactions that have occurred on the device. By applying each of the recorded game software download transactions since a selected time to the software configuration recorded at the selected time, a software configuration is obtained. The software auditing server may compare the software configuration derived from applying these transactions on a gaming device with a current software configuration obtained from the gaming device. After the comparison, the software-auditing server may generate a reconciliation report that confirms that the download transaction records are consistent with the current software configuration on the device. The report may also identify any inconsistencies. In another embodiment, both the gaming device and the software auditing server may store a record of the download transactions that have occurred on the gaming device and the software auditing server may reconcile these records.

There are many possible interactions between the components described with respect to FIG. 10. Many of the interactions are coupled. For example, methods used for game licensing may affect methods used for game downloading and vice versa. For the purposes of explanation, details of a few possible interactions between the components of the system 1000 relating to software licensing and software downloads have been described. The descriptions are selected to illustrate particular interactions in the game system 1000. These descriptions are provided for the purposes of explanation only and are not intended to limit the scope of example embodiments described herein.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

It is claimed:

1. A computer-based gaming method implemented in a gaming network, the method comprising:
controlling a first gaming session relating to a first wager-based Perceived Skill Game conducted at a first gaming machine;
predetermining a first final game outcome associated with a first player participating in the first gaming session;
receiving, during the first gaming session, first game play input from the first player via the first gaming machine;
dynamically effecting a game state of the first gaming session using the received first game play input;
generating, via an automated computerized process, first Perceived Game Control instructions (“PSG instructions”) for dynamically affecting the game state of the first gaming session in a manner which facilitates an occurrence of the first final game state outcome at the end of the first gaming session; and
dynamically effecting, using the first Perceived Game Control instructions, the game state of the first gaming session to thereby cause the occurrence of the first final game state outcome at the end of the first gaming session.

2. The method of claim 1 further comprising:
predetermining a second final game outcome associated with a second player participating in the first gaming session;
receiving, during the first gaming session, second game play input from the second player via a second gaming machine;
dynamically effecting a game state of the first gaming session using the received second game play input;
generating, via an automated computerized process, second Perceived Game Control instructions (“PSG instructions”) for dynamically affecting the game state of the first gaming session in a manner which facilitates an occurrence of the second final game state outcome at the end of the first gaming session; and
dynamically effecting, using the second Perceived Game Control instructions, the game state of the first gaming session to thereby cause the occurrence of the second final game state outcome at the end of the first gaming session.

3. The method of claim 1 further comprising:
dynamically effecting, using the first Perceived Game Control instructions, at least one environmental variable relating to game play activity of the first gaming session to thereby cause the occurrence of the first final game state outcome at the end of the first gaming session.

4. The method of claim 1 further comprising:
dynamically effecting the first player's performance and/or achievements in the first gaming session using the received first game play input; and
wherein the dynamic effecting of the game state of the first gaming session using the first Perceived Game Control instructions is implemented in a manner so as not to make the first player aware of the predetermination of the first final game outcome.

5. The method of claim 1 wherein the first final game outcome is determined before an occurrence of an end of the first gaming session.

6. The method of claim 1 wherein the first final game outcome is determined before the first player engages in active game play activities in the first gaming session.

7. The method of claim 1 wherein the first final game outcome is determined solely based on randomness.

8. The method of claim 1 wherein the determination of the first final game outcome not influenced by the first player's game play input during the first gaming session.

9. The method of claim 1 further comprising:
preventing the determination of the first final game outcome from being influenced by the first player's game play input during the first gaming session.

10. The method of claim 1 further comprising:
preventing the first player's game play input during the first gaming session from influencing the first final game outcome of the first gaming session.

11. The method of claim 1 further comprising:
dynamically adjusting an amount of influence that the first player's game play input has on the game state of the first gaming session in a manner which facilitates the occurrence of the first final game state outcome at the end of the first gaming session.

12. A gaming system in a gaming network, comprising:
at least one gaming controller;
at least one interface operable to provide a communication link to at least one network device; and
memory;
the system being operable to:
control a first gaming session relating to a first wager-based Perceived Skill Game conducted at a first gaming machine;
predetermine a first final game outcome associated with a first player participating in the first gaming session;
receive, during the first gaming session, first game play input from the first player via the first gaming machine;
dynamically effect a game state of the first gaming session using the received first game play input;
generate, via an automated computerized process, first Perceived Game Control instructions (“PSG instructions”) for dynamically affecting the game state of the first gaming session in a manner which facilitates an occurrence of the first final game state outcome at the end of the first gaming session; and
dynamically effect, using the first Perceived Game Control instructions, the game state of the first gaming session to thereby cause the occurrence of the first final game state outcome at the end of the first gaming session.

13. The system of claim 12 being further operable to:
predetermine a second final game outcome associated with a second player participating in the first gaming session;
receive, during the first gaming session, second game play input from the second player via a second gaming machine;
dynamically effect a game state of the first gaming session using the received second game play input;
generate, via an automated computerized process, second Perceived Game Control instructions (“PSG instructions”) for dynamically affecting the game state of the first gaming session in a manner which facilitates an occurrence of the second final game state outcome at the end of the first gaming session; and
dynamically effect, using the second Perceived Game Control instructions, the game state of the first gaming session to thereby cause the occurrence of the second final game state outcome at the end of the first gaming session.

14. The system of claim 12 being further operable to:
dynamically effect, using the first Perceived Game Control instructions, at least one environmental variable relating to game play activity of the first gaming session to thereby cause the occurrence of the first final game state outcome at the end of the first gaming session.

15. The system of claim 12 being further operable to:
dynamically effect the first player's performance and/or achievements in the first gaming session using the received first game play input; and
wherein the dynamic effecting of the game state of the first gaming session using the first Perceived Game Control instructions is implemented in a manner so as not to make the first player aware of the predetermination of the first final game outcome.

16. The system of claim 12 wherein the first final game outcome is determined before an occurrence of an end of the first gaming session.

17. The system of claim 12 wherein the first final game outcome is determined before the first player engages in active game play activities in the first gaming session.

18. The system of claim 12 wherein the first final game outcome is determined solely based on randomness.

19. The system of claim 12 wherein the determination of the first final game outcome not influenced by the first player's game play input during the first gaming session.

20. The system of claim 12 being further operable to:
prevent the determination of the first final game outcome from being influenced by the first player's game play input during the first gaming session.

21. The system of claim 12 being further operable to:
prevent the first player's game play input during the first gaming session from influencing the first final game outcome of the first gaming session.

22. The system of claim 12 being further operable to:
dynamically adjust an amount of influence that the first player's game play input has on the game state of the first gaming session in a manner which facilitates the occurrence of the first final game state outcome at the end of the first gaming session.

23. A gaming apparatus comprising:
a computer usable medium having computer readable code embodied therein, the computer readable code comprising:
means for controlling a first gaming session relating to a first wager-based Perceived Skill Game conducted at a first gaming machine;
means for predetermining a first final game outcome associated with a first player participating in the first gaming session;
means for receiving, during the first gaming session, first game play input from the first player via the first gaming machine;
means for dynamically effecting a game state of the first gaming session using the received first game play input;
means for generating, via an automated computerized process, first Perceived Game Control instructions (“PSG instructions”) for dynamically affecting the game state of the first gaming session in a manner which facilitates an occurrence of the first final game state outcome at the end of the first gaming session;
means for dynamically effecting, using the first Perceived Game Control instructions, the game state of the first gaming session to thereby cause the occurrence of the first final game state outcome at the end of the first gaming session; and
wherein the first final game outcome of the first gaming session is not influenced by the first player's game play input during the first gaming session.
